(19) United States
(12) Patent Application Publication
(10) Pub. No.: US 2025/0385866 A1
(43) Pub. Date: Dec. 18, 2025

(54) METHODS, APPARATUS, AND SYSTEMS FOR TREE-BASED ROUTING IN COMMUNICATION NETWORKS

(71) Applicants: Peter Ashwood-Smith, Kanata (CA); Medhi Arashmid Akhavain Mohammadi, Ottawa (CA)

(72) Inventors: Peter Ashwood-Smith, Kanata (CA); Medhi Arashmid Akhavain Mohammadi, Ottawa (CA)

(73) Assignee: HUAWEI TECHNOLOGIES CO., LTD., SHENZHEN (CN)

(21) Appl. No.: 18/741,295

(22) Filed: Jun. 12, 2024

(51) Int. Cl. H04L 45/48; H04L 45/00

(52) U.S. Cl. CPC H04L 45/48; H04L 45/32

(57) ABSTRACT

Methods, apparatus, and systems for tree-based routing in communication networks are disclosed. At a network node in a communication network, a restriction associated with a flooding message for building a routing tree in the communication network is determined, and the flooding message is handled, at the network node, according to the restriction. Determining a restriction may involve, for example, establishing the restriction or obtaining the restriction from the flooding message or configuration. The following are examples of handling a flooding message according to a restriction: including an indication of the restriction in the flooding message and transmitting the flooding message with the indication included in the flooding message; processing a received flooding message where the restriction is satisfied and otherwise discarding the flooding message; or transmitting a received flooding message where the restriction is satisfied, to all neighboring nodes or only neighboring nodes at which the restriction is satisfied.

### TECHNICAL FIELD

The present application relates to communications, and in particular to routing in communication networks based on trees.

### BACKGROUND

Flooding protocols for building trees in communication networks include the Spanning Tree Protocol (STP) and variations like Multiple Spanning Tree Protocol (MSTP). Routing for Internet Protocol (RIP) is another example. These are all methods of building a tree which is then followed by packets to reach the root of the tree, or to reach another leaf by following towards the root of the tree. A tree is created from the root using floods of packets that may carry distance information from the root. Loops are pruned to produce a minimal spanning tree by keeping shorter distance routes when confronted with two possible ways to reach the root (or roots).

Once a tree is built, it is possible to follow the tree to get from any leaf to any other leaf and to learn where the leaves are. The information on how to reach a root or a leaf is stored in intermediate nodes and is used to forward packets. This is referred to as a Forwarding Table or Forwarding Information Base (FIB).

This idea can be extended to multiple roots, and RIP does this for IP by creating a tree from each node, effectively creating full shortest path forwarding trees to all destinations (IP subnets).

For example, a tree can be built by flooding from a root outwards among nodes capable of forwarding back to that root. Loops are avoided by checking for an identical ID and shorter routes can override longer ones by checking distance. Flooded messages can carry age, in which case younger messages override older entries. The result is that nodes within some distance of the root can forward down the tree to the root based on full or partial matching of a root identifier. This example is similar to RIP/STP/MSTP.

According to another example, a tree may be built and maintained by continuously sending messages from a root along all adjacencies. Features such as aging out, avoiding loops, and dropping longer paths may be provided. Different identifier types are possible. Internet Protocol (IP) addresses are used by RIP. Medium Access Control (MAC) addresses are used by STP/MSTP. These trees allow any node on the tree to find its way back to the root. Multiple roots allow nodes to find a way to different roots based on different IDs (RIP). A root can generate different trees if it originates a different ID for each tree (MSTP).

In a further example, the path to the root is produced automatically by the flooding protocol and stored on intermediate forwarding tables. However, paths to the leaves (unless they are also a root of another tree (RIP)) are not known and must be learned (STP/MSTP). The normal method is for a packet flow from a leaf (A) to make its way to a known desired root R, and as it flows down the tree intermediate nodes (B, C, for example) record that A is the reverse of the direction from which a packet arrived at the intermediate node (A->, B->, C->, in this example).

These examples all use floods, carry distance information in flooded packets, update the distance and re-forward those packets, prune loops, and compare different distances in different packets to pick proper branches for the tree such that the tree is a Minimum Spanning Tree or Shortest Path First Tree.

Such approaches to tree building do not allow a tree to be aimed in particular directions, or in other words to adjust to topography. A tree spans in all directions around the root of the tree but is not aimed. This means that to reach a certain distance, all distances (or hop counts) around the root will require equal and often unnecessary work and energy to be spent. This is not ideal, for example, where nodes are unequally distributed around a root and certain areas are of more or less benefit for tree building.

These approaches also do not allow routing beyond a tree. If a tree is limited in scope (distance) or hops for scalability, for example, then there is no way for packets beyond that distance or number of hops to be routed. Thus, such approaches do not allow a packet that is outside of a flooded region in which a tree has been built to ever find a root.

It is generally desirable to provide improved techniques related to tree building and tree-based routing in communication networks.

### SUMMARY

Some embodiments disclosed herein enable tree building to be adjusted to network topography.

The present disclosure also encompasses embodiments that provide for routing beyond a tree.

According to a first aspect of the present disclosure, a method that is also referred to below as a method of example 1 involves determining, at a network node in a communication network, a restriction associated with a flooding message for building a routing tree in the communication network. Such a method may also involve handling the flooding message, at the network node, according to the restriction.

An example 2 relates to the method of example 1, wherein handling the flooding message involves including an indication of the restriction in the flooding message; and transmitting the flooding message with the indication included in the flooding message.

An example 3 relates to the method of example 2, wherein transmitting the flooding message involves transmitting the flooding message only to one or more other network nodes in the communication network at which the restriction is satisfied.

An example 4 relates to the method of example 1, further including receiving the flooding message, and wherein handling the flooding message involves processing the flooding message where the restriction is satisfied, and otherwise discarding the flooding message.

An example 5 relates to the method of example 4, wherein handling the flooding message further involves transmitting the flooding message after processing, where the restriction is satisfied. Transmitting the flooding message after processing may involve transmitting to neighboring nodes of the network node in the communication network, or transmitting only to one or more of the neighboring nodes at which the restriction is satisfied. The flooding message transmitted in this example (and elsewhere herein) may be the flooding message received in example 4, with or without some processing such as to set values to one or more fields included in the received flooding message. The flooding message transmitted in this example may instead be a newly generated flooding message which includes some or all of the information of the received flooding message, and the new flooding message may further include some information that is not included in the received flooding message.

An example 6 relates to the method of example 4, or example 5, wherein determining the restriction involves obtaining the restriction from the flooding message.

An example 7 relates to the method of example 1, or any one of examples 1 to 6, wherein the restriction is based on any one or more of the following: angles relative to a root node of the routing tree, a distance from the root node of the routing tree, a set of network node identities.

An example 8 relates to the method of claim 1, or any one of examples 1 to 6, wherein the restriction is one of multiple restrictions associated with the flooding message. The multiple restrictions may be or include any one or more of the following: restrictions based on respective angles relative to a root node of the routing tree, restrictions based on respective distances from the root node of the routing tree, restrictions based on respective times, restrictions based on respective levels of loading in the communication network, restrictions based on respective sets of network node identities.

An example 9 relates to the method of example 1, or any one of examples 1 to 8, further including determining, at the network node, a revised restriction that is based on the restriction and a second restriction associated with building a second routing tree in the communication network; and handling a second flooding message, by the network node, according to the revised restriction.

An example 10 relates to the method of example 1, or any one of examples 1 to 9, wherein the network node has an address in the communication network that is indicative of a geographic location of the network node, to enable routing toward the network node from outside the routing tree.

According to another aspect, a communication apparatus is configured to perform the method of any one of examples 1 to 10, or any other method disclosed herein.

According to a further aspect, a communication apparatus has a function of implementing the method of any one of examples 1 to 10, or any other method disclosed herein, and may be configured to perform such a method. For example, the communication apparatus may include a corresponding module, unit, or means for performing operations in any disclosed method. The module, unit, or means may be specifically implemented by using software, may be implemented by using hardware, or may be implemented by using software in combination with hardware.

A communication apparatus according to another aspect includes a memory and one or more processors. The memory is configured to store a part or all of a necessary computer program or instructions for implementing a function in the method of any one of examples 1 to 10, or any other method disclosed herein. The one or more processors may execute the computer program or the instructions, and when the computer program or the instructions is/are executed, the communication apparatus is enabled to implement any disclosed method.

In some embodiments, a communication apparatus may further include an interface circuit, and the processor is configured to communicate with another apparatus or component through the interface circuit.

In some embodiments, the communication apparatus may further include the memory.

A communication apparatus may be a terminal, a module in a terminal, or a chip responsible for a communication function in a terminal, for example, a modem chip (also referred to as a baseband chip) or an SoC chip or an SIP chip that includes a modem module.

Another apparatus example, also referred to below as an apparatus of example 11, is an apparatus for a network node in a communication network. The apparatus of example 11 includes a processing unit, configured to determine a restriction associated with a flooding message for building a routing tree in the communication network. The processing unit is further configured to handle the flooding message according to the restriction.

An example 12 relates to the apparatus of example 11, wherein the processing unit is configured to handle the flooding message by including an indication of the restriction in the flooding message, and wherein the apparatus also includes a transmitting unit, configured to transmit the flooding message with the indication included in the flooding message.

An example 13 relates to the apparatus of example 12, wherein the transmitting unit is configured to transmit the flooding message only to one or more other nodes in the communication network at which the restriction is satisfied.

An example 14 relates to the apparatus of example 11, further including a receiving unit, configured to receive the flooding message, and wherein the processing unit is configured to handle the flooding message by processing the flooding message where the restriction is satisfied, and otherwise discarding the flooding message.

An example 15 relates to the apparatus of example 14, further including a transmitting unit, configured to transmit the flooding message after processing, where the restriction is satisfied. The transmitting unit is configured to transmit the flooding message, after processing: either to neighboring nodes of the network node in the communication network, or to only one or more of the neighboring nodes at which the restriction is satisfied.

An example 16 relates to the apparatus of example 14, or example 15, wherein the processing unit is configured to determine the restriction by obtaining the restriction from the flooding message.

An example 17 relates to the apparatus of example 11, or any one of examples 11 to 16, wherein the restriction is based on any one or more of the following: angles relative to a root node of the routing tree, a distance from the root node of the routing tree, a set of network node identities.

An example 18 relates to the apparatus of example 11, or any one of examples 11 to 16, wherein the restriction is one of multiple restrictions associated with the flooding message. The multiple restrictions may include any one or more of the following: restrictions based on respective angles relative to a root node of the routing tree, restrictions based on respective distances from the root node of the routing tree, restrictions based on respective times, restrictions based on respective levels of loading in the communication network, restrictions based on respective sets of network node identities.

An example 19 relates to the apparatus of example 11, or any one of examples 11 to 18, wherein the processing unit is further configured to determine a revised restriction that is based on the restriction and a second restriction associated with building a second routing tree in the communication network, and handle a second flooding message according to the revised restriction.

An example 20 relates to the apparatus of example 11, or any one of examples 11 to 19, wherein the network node has an address in the communication network that is indicative of a geographic location of the network node, to enable routing toward the network node from outside the routing tree.

A memory or storage medium need not necessarily or only be implemented in or in conjunction with an apparatus or a processor. According to another aspect, a non-transitory computer-readable (or processor-readable) storage medium is described. The storage medium stores computer-readable/executable (or processor-readable/executable) instructions, and when a computer (or processor, or more generally one or more computers or one or more processors) reads and executes the computer-readable/executable (or processor-readable/executable) instructions, the computer(s) or processor(s) is/are enabled or caused to perform the method of any one of examples 1 to 10, or any other method disclosed herein.

Another aspect provides a computer program product. When a computer or processor reads and executes the computer program product, the computer or processor is enabled or caused to perform the method of any one of examples 1 to 10 or any other method disclosed herein.

Another form of a computer program product stores instructions which, when executed, cause an apparatus to perform the method of any one of examples 1 to 10 or any other method disclosed herein.

Programming or instructions stored by a computer readable storage medium may include instructions to, or to cause a computer, processor, device, apparatus, or a component thereof to, perform, implement, support, or enable the method of any one of examples 1 to 10 or any other methods or features disclosed herein.

A system is also disclosed, and may include network nodes among which a flooding message for building a routing tree is distributed. Each of the network nodes is configured to perform the method of any one of claims 1 to 10 or any other method disclosed herein.

This application encompasses various embodiments, including not only method embodiments, but also other embodiments such as apparatus embodiments and embodiments related to non-transitory computer readable storage media. Embodiments may incorporate, individually or in combinations, the features disclosed herein.

### BRIEF DESCRIPTION OF THE DRAWINGS

For a more complete understanding of the present embodiments, and the advantages thereof, reference is now made, by way of example, to the following descriptions taken in conjunction with the accompanying drawings.

FIG. 1 provides, as an illustrative example, a simplified schematic illustration of a communication system.

FIG. 2 illustrates another example for the communication system in FIG. 1.

FIG. 3A illustrates an example of an apparatus wirelessly communicating with another apparatus in a communication system.

FIG. 3B illustrates another example of an apparatus.

FIG. 3C illustrates yet another example of an apparatus.

FIG. 4A illustrates an example of an integrated TN and NTN in which terrestrial transmit and receive points (T-TRPs) communicate with non-terrestrial transmit and receive points (NT-TRPs) that are part of a satellite constellation.

FIG. 4B illustrates another example of an integrated TN and NTN, in which a satellite constellation effectively acts as a gateway for T-TRPs.

FIG. 4C illustrates yet another example of an integrated TN and NTN, in which NT-TRPs communicate with T-TRPs through a core network.

FIG. 5 illustrates directed flooding to build a routing tree according to an embodiment.

FIG. 6 illustrates another example of directed flooding to build a routing tree.

FIG. 7 illustrates a directed flooding example with multiple flood sectors.

FIG. 8 illustrates another directed flooding example with multiple flood sectors.

FIG. 9 illustrates a directed flooding example for two adjacent ground stations.

FIG. 10 illustrates a directed flooding example in which one of the ground stations in FIG. 9 takes over the flood sector of the other.

FIG. 11 illustrates another example of directed flooding to build a routing tree according to an embodiment.

FIG. 12 illustrates an example of geographic routing.

FIG. 13 illustrates a more detailed example of geographic routing.

FIG. 14 illustrates an example of reverse source route checking.

FIG. 15 includes flow diagrams illustrating general example methods according to embodiments.

FIG. 16 is a block diagram illustrating an example apparatus.

### DETAILED DESCRIPTION

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

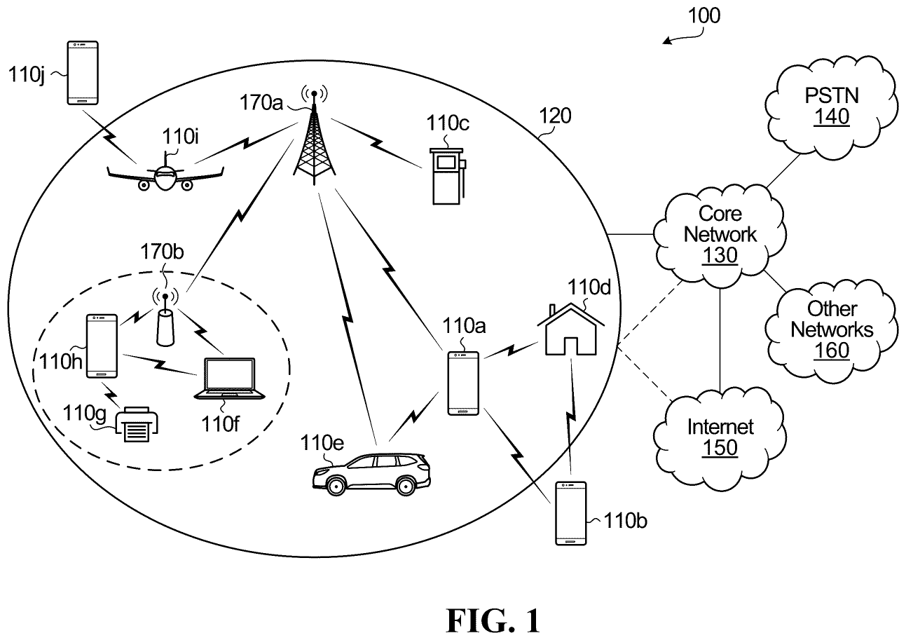

Referring to FIG. 1, as an illustrative example, a simplified schematic illustration of a communication system is provided. The communication system 100 may comprise a radio access network 120. The radio access network (RAN) 120 may be a next generation (e.g. 6th generation (6G) or later) radio access network, or a legacy (e.g. 5th generation (5G), 4th generation (4G), 3rd generation (3G) or 2nd generation (2G)) radio access network. The RAN 120 may be a network using other radio access technology. In some implementations, 6G radio access refers to a next generation air interface of standards which may comprise both terrestrial networks (TNs) and non-terrestrial networks (NTNs), and more details will be described below. One or more communication electronic device (ED) 110a, 110b, 110c, 110d, 110c, 110f, 110g, 110h, 110i, 110j (generically referred to as 110) may be interconnected to one another or connected to one or more network nodes 170a, 170b (generically referred to as 170) in the RAN 120. A core network (CN) 130 may be a part of the communication system and may be dependent or independent of the radio access technology used in the communication system 100. The communication system 100 may also comprise a public switched telephone network (PSTN) 140, the internet 150, and other networks 160.

In general, the communication system 100 enables communication of multiple wireless or wired elements. The communication system 100 may provide content, such as voice, data, video, and/or text, via broadcast, multicast, groupcast, unicast, etc. The communication system 100 may operate by sharing resources, such as carrier spectrum bandwidth, among its constituent elements.

The communication system 100 may provide a wide range of communication services and applications including enhanced Mobile Broadband (cMBB) services, ultra-reliable low-latency communication (URLLC) services, massive machine type communication (mMTC) services, integrated sensing and communication (ISAC), immersive communication, massive communication, Hyper reliable and low-latency communication, ubiquitous connectivity, integrated AI and communication, and other services that can be provided by a future generation communication system. The communication system 100 may provide other services and applications such as earth monitoring, remote sensing, passive sensing and positioning, navigation and tracking, autonomous delivery and mobility, etc.

The communication system 100 may include a terrestrial communication system (or network) and/or a non-terrestrial communication system (or network). The communication system 100 may provide a high degree of availability and robustness through a joint operation of a terrestrial communication system and a non-terrestrial communication system. For example, integrating a non-terrestrial communication system (or components thereof) into a terrestrial communication system can result in a heterogeneous network comprising multiple layers. The heterogeneous network may achieve better overall performance through efficient multi-link joint operation, more flexible functionality sharing, and faster physical layer link switching between terrestrial networks and non-terrestrial networks. The terrestrial communication system and the non-terrestrial communication system could be considered sub-systems of the communication system 100.

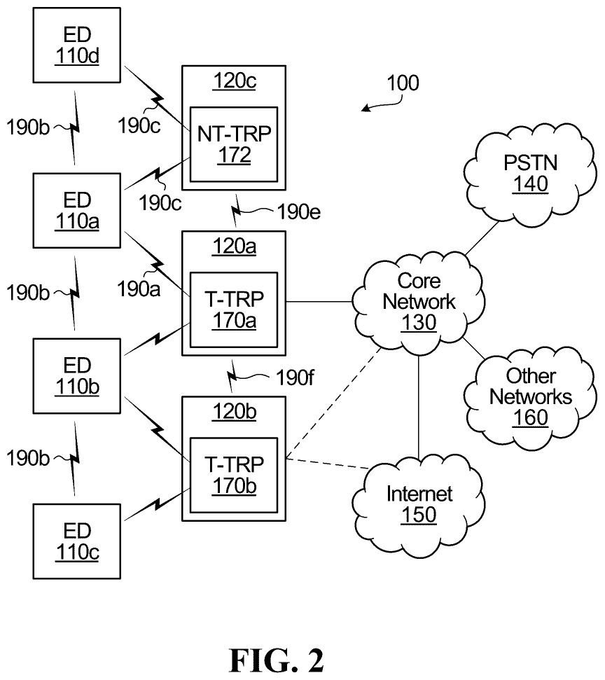

FIG. 2 illustrates another example for communication system 100. As described earlier, the communication system 100 may include EDs 110a, 110b, 110c, 110d (generically referred to as ED 110), RAN 120a, 120b, and one or more of a CN 130, a PSTN 140, the internet 150, and other networks 160. In addition, the communication system 100 may also include a non-terrestrial network (NTN) 120c. The RANs 120a, 120b may include respective network nodes 170a, 170b such as base stations 170a, 170b, which may be generically referred to as terrestrial network (TN) devices or terrestrial transmit and receive points (T-TRPs) 170a, 170b (generically referred to as 170). As referred to herein, the terms “TRP” and “base station” may be used interchangeably unless explicitly noted otherwise in a given example or section. For brevity, this disclosure may primarily refer to base station; however, absent an explicit limitation, references to TRP are merely non-limiting instances of interchangeable use. The T-TRPs 170a, 170b may be base stations mounted on a building or tower. In one implementation, the NTN 120c includes a RAN node such as base station 172, which may be generically referred to as an NTN device, a non-terrestrial node, a non-terrestrial network device, a non-terrestrial base station, or a non-terrestrial transmit and receive point (NT-TRP) 172.

In some implementations, the NT-TRP 172 is not attached to the ground, for example, in the case of an airborne base station. An airborne base station may be implemented using communication equipment supported or carried by a flying device. For example, a flying device may include an airborne platform (e.g. a blimp or an airship), balloon, drone (e.g. quadcopter), and other types of aerial vehicles. In some implementations, an airborne base station may be supported or carried by an unmanned aerial system (UAS) or an unmanned aerial vehicle (UAV), such as a drone. An airborne base station may be a moveable or mobile base station that can be flexibly deployed in different locations to meet network demand. A satellite base station is another example of a non-terrestrial base station. A satellite base station may be implemented using communication equipment supported or carried by a satellite. A satellite base station may also be referred to as an orbiting base station. High altitude platforms are yet another example of non-terrestrial base stations, including international mobile telecommunication base stations.

As referred to herein, and unless specified otherwise, a “TRP” may also refer to a T-TRP or an NT-TRP, a “T-TRP” may also refer to a “TN TRP”, and an “NT-TRP” may also refer to a “NTN TRP”. The NTN 120c may be considered to be a radio access network (RAN), with operational aspects in common with the RANs 120a, 120b. The NTN 120c may include at least one NTN device and at least one corresponding terrestrial network device, the at least one NTN device may function as a transport layer device and the at least one corresponding terrestrial network device may function as a RAN node, which communicates with the ED 110 via the non-terrestrial network device. In addition, there may be an NTN gateway on the ground (i.e., referred to as a terrestrial network device) that also functions as a transport layer device to communicate with both the NTN device and the RAN node. The RAN node may communicate with the ED 110 via the NTN device and the NTN gateway. In some implementations, the NTN gateway and the RAN node may be located in the same device.

A base station (also referred to as a TRP as stated above) 170 may be a network element in radio access network responsible for radio transmission and reception in one or more cells to or from the user equipment. Base station 170 may be known by other names in some implementations, such as a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a terrestrial node, a terrestrial network device, a terrestrial base station, a positioning node, among other possibilities. The base station 170 may be a macro base station (BS), a pico BS, a relay node, a donor node, or the like, or combinations thereof. When a base station 170 performs (or is configured to perform) a method described herein, it may be interpreted as the base station, one or more modules (or units) in the base station, a circuit or chip, or a combination thereof, may perform the method. For example, the circuit or chip may include a modem chip, also referred to as a baseband chip, a system on chip (SoC) including a modem core, system in package (SIP)), and the like, and may be responsible for one or more communication functions in the base station.

The EDs 110a-110d and TRPs 170a-170b, 172 are examples of communication equipment that can be configured to implement some or all of the operations and/or embodiments described herein. The T-TRP 170a forms part of the RAN 120a, which may include other TRPs, and/or other devices. Also, the TRP 170b forms part of the RAN 120b, which may include other TRPs, and/or devices. Each TRP 170a, 170b may transmit and/or receive wireless signals within a particular geographic region or area, sometimes referred to as a “cell” or “coverage area”. The TRPs 170a-170b may be responsible for allocating and/or configuring resources and transmission and/or reception in a set of cells. A cell may be a Radio network object that can be uniquely identified from a (cell) identification that is broadcasted over a geographical region or area from base stations associated with the cell. A cell can operate in either FDD or TDD mode. A cell may also refer to the carrier frequencies within the DL/UL carrier bandwidth resources of a single standalone carrier or a component carrier in a carrier aggregation mode. A cell may be further divided into cell sectors, and a base station 170a-170b may, for example, employ multiple transceivers to provide service to multiple sectors. In some implementations, there may be established pico or femto cells where the radio access technology supports such. In some implementations, multiple transceivers could be used for each cell, for example using multiple-input multiple-output (MIMO) technology. The number of RAN 120a-120b shown is an example only. Any number of RAN may be contemplated when devising the communication system 100.

Any base station may be a single element, as shown, or multiple elements, distributed in the corresponding RAN, or otherwise. In some implementations, a plurality of RAN nodes coordinate to assist the ED 110 in implementing radio access, and different RAN nodes separately implement different functions of the base station. For example, the RAN node may be a central unit (CU), a distributed unit (DU), a CU-control plane (CP), a CU-user plane (UP), or a radio unit (RU) etc. The CU and the DU may be separately deployed, or may be included in a same element (i.e., a baseband unit (BBU)). The RU may be included in a radio frequency device or a radio frequency unit (i.e., a remote radio unit (RRU), an active antenna unit (AAU), or a remote radio head (RRH)). In different systems, the CU (or the CU-CP and the CU-UP), the DU, or the RU may also have different names, but a person skilled in the art may understand meanings thereof. For example, in an open radio access network (ORAN) system, a CU may also be referred to as an open CU (O-CU), a DU may also be referred to as an open DU (O-DU), and a CU-CP may also be referred to as an open CU-CP (O-CU-CP). The CU-UP may also be referred to as an open CU-UP (O-CU-UP), and the RU may also be referred to as an open RU (O-RU). Any one of the CU (or the CU-CP, the CU-UP), the DU, and the RU may be implemented by using a software module, a hardware module, or a combination of a software module and a hardware module.

Further, communication(s) between different devices/apparatuses in various embodiments of this application may refer to direct communication between different devices/apparatuses (that is, no forwarding is required by another device/apparatuses), or may refer to communication(s) between different devices/apparatuses via another device/apparatus (that is, forwarding is required by another device/apparatus). Alternatively, such further communication(s) may refer to that a functional unit inside the device/apparatus uses another functional unit in the device/apparatus to communicate with another device/apparatus. In other words, “sending (or transmitting) information to . . . (an ED or a base station)” in this application may be understood as that a destination endpoint of the information is an ED or a base station. It may include sending/transmitting information directly or indirectly to an ED or a base station. Similarly, “receiving information from . . . (an ED or a base station)” may be understood as that a source endpoint of the information is an ED or a base station, and may include directly or indirectly receiving information from an ED or a base station. Necessary processing such as format conversion, digital-to-analog conversion, amplification, and filtering may be performed on the information between the source endpoint that sends the information and the destination endpoint. However, the destination endpoint may understand valid information from the source endpoint. Similar descriptions in this application may be understood similarly. Details are not described herein again. In the present disclosure, the terms “send” and “transmit” may be used interchangeably in embodiments of this application.

The ED 110 is used to connect persons, objects, machines, etc. The ED 110 may be widely used in various scenarios including, for example, cellular communications, device-to-device (D2D), vehicle to everything (V2X), peer-to-peer (P2P), machine-to-machine (M2M), MTC, internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to but not limited to) as a user equipment (UE) or a user device or a terminal device, a wireless transmit/receive unit (WTRU), a mobile station, a fixed or mobile subscriber unit, a cellular telephone, a station (STA), a MTC device, a personal digital assistant (PDA), a smartphone, a laptop, a computer, a tablet, a wireless sensor, a consumer electronics device, a smart book, a vehicle, a car, a truck, a bus, a train, or an IoT device, wearable devices (such as a watch, a pair of glasses, head mounted equipment, etc.), an industrial device, or an apparatus in (e.g. module, modem, or chip) or comprising the forgoing devices, among other possibilities. Future generation EDs 110 may be referred to using other terms. When an ED 110 performs (or is configured to perform) a method described herein, it may be interpreted as the ED, one or more module (or units) in the ED, a circuit or chip, or a combination thereof, may perform the method. For example, the circuit or chip may include a modem chip, also referred to as a baseband chip, a system on chip (SoC) including a modem core, or system in package (SIP)), and the like, and may be responsible for one or more communication functions in the ED.

Each ED 110 connected to TRPs 170a-170b, and/or TRPs 172 can be dynamically or semi-statically turned-on (i.e., established, activated, or enabled), turned-off (i.e., released, deactivated, or disabled) and/or configured in response to one of more of: connection availability and connection necessity.

Any ED 110 may be alternatively or additionally configured to interface, access, or communicate with any TRPs 170a, 170b and 172, the Internet 150, the CN 130, the PSTN 140, the other networks 160, or any combination of the preceding. In some examples, ED 110a may communicate an uplink (UL) and/or downlink (DL) transmission over a terrestrial air interface 190a with station-TRP 170a. In some examples, the EDs 110a, 110b, 110c, and 110d may also communicate directly with one another via one or more sidelink (SL) air interfaces 190b. In some examples, ED 110a, 110d may communicate an UL and/or DL transmission over a non-terrestrial air interface 190c with NT-TRP 172.

An air interface (e.g., 190a, 190b, 190c) generally includes a number of components and associated parameters that collectively specify how a transmission is to be sent and/or received over a wireless communications link between two or more communicating devices such as ED and base station. For example, an air interface may include one or more components defining the waveform(s), frame structure(s), multiple access scheme(s), protocol(s), coding scheme(s) and/or modulation scheme(s) for conveying information (e.g., data) over a wireless communications link. The air interfaces 190a and 190b may use similar communication technology, such as any suitable radio access technology.

The non-terrestrial air interface 190c can enable communication between the EDs 110a, 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 172 for multicast transmission.

The TRPs 170a-170b, 172 may communicate with one another over one or more air interfaces 190e, 190f using wireless communication links (e.g., radio frequency (RF), microwave, infrared (IR), etc.) or wired communication links. The air interfaces 190e, 190f may utilize any suitable radio access technology, and may be substantially similar to the air interfaces 190a, 190c over which the EDs 110a-110d communicate with one or more of the TRP 170a-170b, 172 or they may be substantially different. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA).

The RANs 120a and 120b are in communication with the CN 130 to provide the EDs 110a 110b, and 110c with various services such as voice, data, and other services. The RANs 120a and 120b and/or the CN 130 may be in direct or indirect communication with one or more other RANs (not shown), which may or may not be directly served by CN 130, and may or may not employ the same radio access technology as RAN 120a, RAN 120b or both. The CN 130 may also serve as a gateway access between (i) the RANs 120a and 120b or EDs 110a 110b, and 110c or both, and (ii) other networks (such as the PSTN 140, the Internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the Internet 150. PSTN 140 may include circuit switched telephone networks for providing plain old telephone service (POTS). Internet 150 may include a network of computers and subnets (intranets) or both, and incorporate protocols, such as internet protocol (IP), transmission control protocol (TCP), user datagram protocol (UDP). EDs 110a 110b, and 110c may be multimode devices capable of operation according to multiple radio access technologies, and incorporate multiple transceivers necessary to support such.

In addition, the communication system 100 may comprise a sensing agent (not shown) to manage the sensed data from ED 110 and/or any one of TRPs 170a-170b, 172. In one implementation, the sensing agent may be part of any one of TRPs 170a-b, 172. In another implementation, the sensing agent is a separate node that can communicate with the CN 130 and/or the RAN 120 (e.g., any one of TRPs 170a-b, 172).

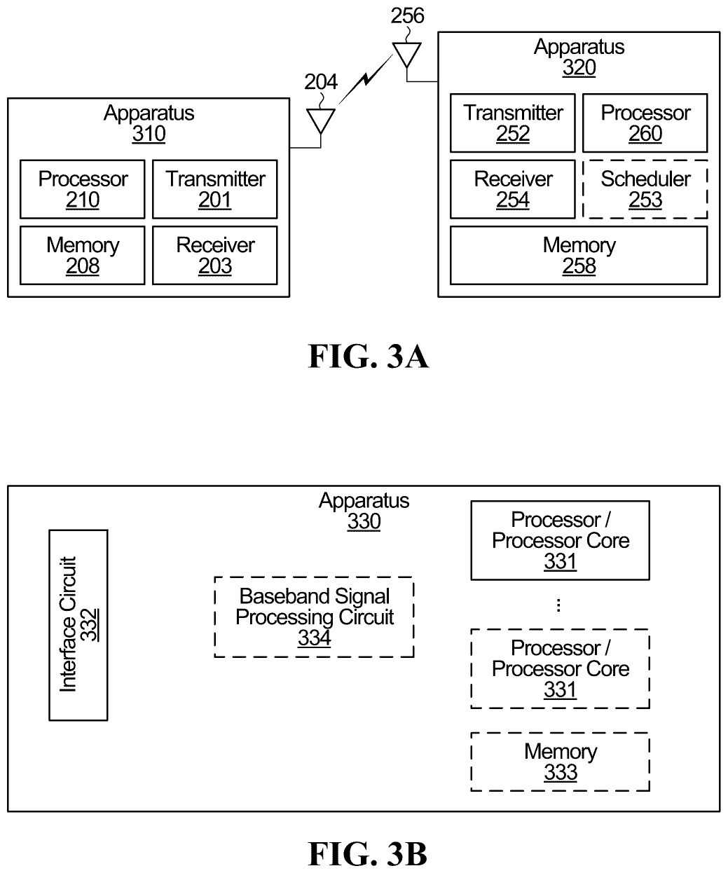

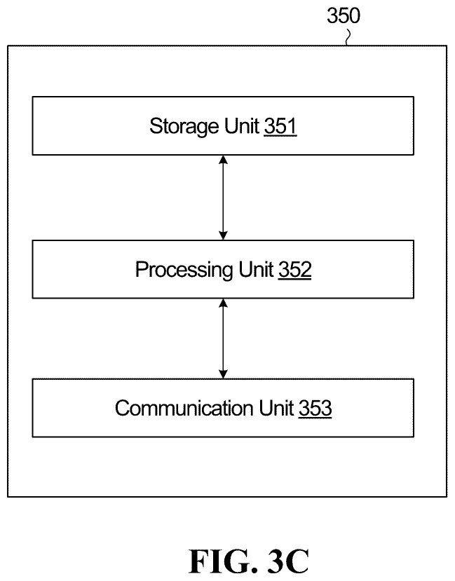

FIG. 3A illustrates an example of an apparatus 310 wirelessly communicating with another apparatus 320 in a communication system (e.g., the communication system 100). The apparatus 310 may be an electronic device (e.g. ED 110). The apparatus 320 may be a network node (e.g. network node 170) such as T-TRP 170 or an NT-TRP 172. Although there is only one apparatus 310, and one apparatus 320 shown in the figure, the number of apparatus 310 and/or 320 could be one or more. For example, one ED 110 may be served by only one T-TRP 170 (or one NT-TRP 172), by more than one T-TRP 170 (or more than one NT-TRP 172). One ED 110 may be served by one or more T-TRP 170 and one or more NT-TRP172. Similarly, one T-TRP 170 (or one NT-TRP172) may serve one or more ED 110.

Apparatus 310 includes at least one processor 210. Only one processor 210 is illustrated to avoid congestion in the drawing. The apparatus 310 may further include a transmitter 201 and a receiver 203 coupled to one or more antennas 204. Only one antenna 204 is illustrated to avoid congestion in the drawing. One, some, or all of the antennas 204 may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals. The apparatus 310 may include at least one memory 208. Only the transmitter 201, receiver 203, processor 210, memory 208, and antenna 204 is illustrated for simplicity, but the apparatus 310 may include one or more other components. In present disclosure, the transceiver (or transmitter 201 and/or receiver 203) may be viewed as an interface circuit.

The memory 208 stores instructions used to perform operations described herein. The memory 208 may also store data used, generated, or collected by the apparatus 310. For example, the memory 208 could store software instructions or modules configured to implement some or all of the functionality and/or embodiments described herein and that are executed by one or more processor 210.

The apparatus 310 may further include one or more input/output devices (not shown) or interfaces. The input/output devices or interfaces permit interaction with a user or other devices in the network. Each input/output device or interface includes any suitable structure for providing information to or receiving information from a user, and/or for network interface communications. Suitable structures include, for example, a speaker, microphone, keypad, keyboard, display, touch screen, etc.

The processor 210 may perform (or control the apparatus 310 to perform) operations (or methods) described herein as being performed by the apparatus 310. For example, the processor 210 performs or controls the apparatus 310 to perform receiving transport blocks (TBs), using a resource for decoding of one of the received TBs, releasing the resource for decoding of another of the received TBs, and/or receiving configuration information configuring a resource. In detail, the operation may include those operations related to preparing a transmission for UL transmission to the apparatus 320; those operations related to processing DL transmissions received from the apparatus 320; and those operations related to processing SL transmission to and from another apparatus 310. Processing operations related to preparing a transmission for UL transmission may include operations such as encoding, modulating, transmit beamforming, and generating symbols for transmission. Processing operations related to processing DL transmissions may include operations such as receive beamforming, demodulating and decoding received symbols. Processing operations related to processing SL transmissions may include operations such as transmit/receive beamforming, modulating/demodulating and encoding/decoding symbols. Depending upon the embodiment, a DL transmission may be received by the receiver 203, possibly using receive beamforming, and the processor 210 may extract signaling from the DL transmission (e.g. by detecting and/or decoding the signaling). An example of signaling may be a reference signal transmitted by the apparatus 320. In some implementations, the processor 210 implements the transmit beamforming and/or the receive beamforming based on the indication of beam direction, e.g. beam angle information (BAI), received from the apparatus 320. In some implementations, the processor 210 may perform operations relating to network access (e.g. initial access) and/or downlink synchronization, such as operations relating to detecting a synchronization sequence, decoding and obtaining the system information, etc. In some implementations, the processor 210 may perform channel estimation, e.g. using a reference signal received from the apparatus 320.

Although not illustrated, the processor 210 may form part of the transmitter 201 and/or part of the receiver 203. Although not illustrated, the memory 208 may form part of the processor 210.

The processor 210, the processing components of the transmitter 201, and the processing components of the receiver 203 may each be implemented by the same or different one or more processors that are configured to execute instructions stored in a memory (e.g. in the memory 208).

The apparatus 320 includes one or more processors 260 (only one processor 260 is illustrated to in the figure). The apparatus 320 may further include at least one transmitter 252 and at least one receiver 254 coupled to one or more antennas 256. Only one antenna 256 is illustrated to avoid congestion in the drawing. One, some, or all of the antennas 256 may alternatively be panels. The transmitter 252 and the receiver 254 may be integrated as a transceiver. The apparatus 320 may further include at least one memory 258. The apparatus 320 may further include scheduler 253. Only the transmitter 252, receiver 254, processor 260, memory 258, antenna 256 and scheduler 253 are illustrated for simplicity, but the apparatus 320 may include one or more other components. In present disclosure, the transceiver (or transmitter 252 and/or receiver 254) may be viewed as an interface circuit.

In some implementations, the parts of the apparatus 320 may be distributed. For example, some of the modules of the apparatus 320 may be located remote from the equipment that houses the antennas 256 for the apparatus 320 (thereby also can be viewed as one or more nodes), and may be coupled to the equipment that houses the antennas 256 over a communication link (not shown) sometimes known as front haul, such as common public radio interface (CPRI). Therefore, in some implementations, the term apparatus 320 may also refer to nodes on the network side that perform processing operations, such as determining the location of the apparatus 310, resource allocation (scheduling), message generation, and encoding/decoding, and that are not necessarily part of the equipment that houses the antennas 256 of the apparatus 320. The nodes may also be coupled to other apparatus 320s. In some implementations, the apparatus 320 may actually be a plurality of nodes that are operating together to serve the apparatus 310, e.g. through the use of coordinated multipoint transmissions, or the use of ORAN system as described above in the application.

The processor 260 performs operations including those related to: preparing a transmission for DL transmission to the apparatus 310, processing an UL transmission received from the apparatus 310, preparing a transmission for backhaul transmission to another apparatus 320, and processing a transmission received over backhaul from another apparatus 320. Processing operations related to preparing a transmission for DL or backhaul transmission may include operations such as encoding, modulating, precoding (e.g. multiple input multiple output (MIMO) precoding), transmit beamforming, and generating symbols for transmission. Processing operations related to processing received transmissions in the UL or over backhaul may include operations such as receive beamforming, demodulating received symbols, and decoding received symbols. The processor 260 may also perform operations relating to network access (e.g. initial access) and/or DL synchronization, such as generating the content of synchronization signal blocks (SSBs), generating the system information, etc. In some implementations, the processor 260 also generates an indication of beam direction, e.g. BAI, which may be scheduled for transmission by a scheduler 253 which will be described below. In some implementations, the processor 260 implements the transmit beamforming and/or receive beamforming based on beam direction information (e.g. BAI) received from another apparatus 320. The processor 260 performs other network side processing operations described herein, such as determining the location of the apparatus 310, determining where to deploy another apparatus 320, etc. In some implementations, the processor 260 may generate signaling, e.g. to configure one or more parameters of the apparatus 310 and/or one or more parameters of another apparatus 320. Any signaling generated by the processor 260 is sent by the transmitter 252. In some implementations, the apparatus 320 implements physical layer processing. In some implementations, the apparatus 320 may implement higher layer functions such as functions at the medium access control (MAC) or radio link control (RLC) layer in addition to physical layer processing. The apparatus 320 may further comprise scheduler 253 coupled to the processor 260 or integrated in the processor 260. The scheduler 253 may be included within or operated separately from the apparatus 320. The scheduler 253 may schedule UL, DL, SL, and/or backhaul transmissions, including issuing scheduling grants and/or configuring scheduling-free (e.g., “configured grant”) resources.

The apparatus 320 may further include a memory 258 storing instructions used to perform operations described herein. The memory 258 may also store data used, generated, or collected by the apparatus 320. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252, and the processing components of the receiver 254 may each be implemented by the same or different one or more processors that are configured to execute instructions stored in a memory, e.g. in the memory 258.

The apparatus 320 and/or the apparatus 310 may include other components, but these have been omitted for the sake of clarity.

Note that “signaling”, as used herein, may alternatively be called control signaling, control message, control information, or message for simplicity. Signaling between a base station (e.g., the TRP 170a-b, 172) and a UE or sensing device (e.g., ED 110), or signaling between a different UE or sensing device (e.g., between ED 110a and ED 110b) may be carried in physical layer signaling (also called as dynamic signaling), which is transmitted in a physical layer control channel. For DL, the physical layer signaling may be known as downlink control information (DCI) which is transmitted in a physical downlink control channel (PDCCH). For UL, the physical layer signaling may be known as uplink control information (UCI) which is transmitted in a physical uplink control channel (PUCCH). For SL, signaling between different UEs or sensing devices (e.g., between ED 110a and ED 110b) may be known as SL control information (SCI) which is transmitted in a physical sidelink control channel (PSCCH). Signaling may be carried in a higher layer (e.g., higher than physical layer) signaling, which is transmitted in a physical layer data channel, e.g. in a physical downlink shared channel (PDSCH) for downlink signaling, in a physical uplink shared channel (PUSCH) for uplink signaling, and in a physical sidelink shared channel (PSSCH) for SL signaling. Higher layer signaling may also be called static signaling, or semi-static signaling. Higher layer signaling may be radio resource control (RRC) protocol signaling or media access control-control element (MAC-CE) signaling. Signaling may be included in a combination of physical layer signaling and higher layer signaling.

It should be noted that in present application, “information”, when different from “message”, may be carried in one single message, or be carried in more than one separate message.

FIG. 3B illustrates an example of an apparatus 330. The apparatus 330 may be a communication device or an apparatus implemented in a communication device such as ED 110 or TRPs 170a-170b, 172. For example, the apparatus implemented in a communication device may be an integrated circuit, which in some contexts may be known by other colloquial names, such as chip, modem, modem chip, baseband chip, or baseband processor. In some implementations, one or more integrated circuits can be packaged into a system-on-chip, a system-in-package, or a multi-chip module. The apparatus may comprise one or more integrated circuits or comprise one or more integrated circuits and other discrete components. In some implementations, the apparatus 330 may be a module in ED 110, or apparatus 310. In some implementations, the apparatus 330 may be a module in one of TRPs 170a-170b, 172, or apparatus 320.

In an example, the apparatus 330 may include one or more processors/processor cores 331, and an interface circuit 332. The apparatus 330 may further include a memory 333. The one or more processors/processor cores 331 are configured to process signals and execute one or more communication protocols. The memory 333 is configured to store at least a part of corresponding computer program instructions and/or data. In an example, the one or more processors (or processor cores) 331 execute the computer program instructions stored in the memory 333 to implement related operations (for example, inputting, outputting, receiving, and transmitting) in the method embodiments disclosed herein. In some implementations, the memory 333 being configured to store the corresponding computer program instructions and/or data may mean that the memory 333 is configured to store all of the corresponding computer program instructions and/or data for execution by the one or more processors/processor cores 331. In some implementations, the memory 333 being configured to store the corresponding computer program instructions and/or data may mean that the memory 333 is configured to store a part of the corresponding computer program instructions and/or data. For example, the part of the corresponding computer program instructions and/or data may include computer program instructions and/or data that need to be currently executed by the one or more processors/processor cores 331. Thus, the memory 333 may store different parts of computer program instructions and/or data for a plurality times for the one or more processors (or processor cores) 331 to perform related operations in the method embodiments disclosed herein. As a communication interface, the interface circuit 332 is configured to implement communication with another component. For example, the interface circuit 332 may communicate a signal with other apparatus/system such as a radio frequency processing apparatus, or processor system. Optionally, to reduce a load of the processors (or processor cores), a baseband signal processing circuit 334 may be also disposed to implement processing of at least a part of baseband signals, including signal demodulation, modulation, encoding, decoding, or the like.

Apparatus 330 may be processor 210 (or 260) in apparatus 310 (or 320), in some scenarios, or included in processor 210 (or 260) in apparatus 310 (or 320) in some scenarios. Apparatus 330 may be or include a baseband chip. In some implementations, the apparatus 330 may be independently packaged into a chip. In some implementations, the apparatus 310 (or 320) includes different types of chips. The apparatus 330 may be packaged into a processor chip (for example, an SoC chip or an SIP chip) with the different types of chips. In some implementations, the apparatus 330 may be packaged into a chip with some or all of circuits of a radio frequency processing system that may further included in the apparatus 310 (or 320).

FIG. 3C illustrates an example of apparatus 350. Apparatus 350 may include corresponding modules or units configured to implement methods and/or embodiments described herein. In some implementations, the apparatus 350 includes a processing unit 352 and a communication unit 353. Optionally, the apparatus 350 may further include a storage unit 351 configured to store apparatus program code (or instructions) and/or data.

The apparatus 350 may be an ED side apparatus, for example, an ED or a module in an ED, or a circuit or a chip responsible for a communication function in an ED. In some implementations, apparatus 350 may be implemented as apparatus 310, accordingly, the processing unit 352 is implemented as processor 210, the communication unit 353 is implemented as transmitter 201 and/or receiver 203, and the storage unit 351 is implemented as memory 208.

The apparatus 350 may be a base station side apparatus, for example, a base station or a module in a base station, or a circuit or a chip responsible for a communication function in a base station. In some implementations, apparatus 350 may be implemented as apparatus 320, accordingly, the processing unit 352 is implemented as processor 260 (the scheduler 253 may also be included), the communication unit 353 is implemented as transmitter 252 and/or receiver 254, and the storage unit 351 is implemented as memory 258.

In some implementations, when the apparatus 350 is an ED 110 or a module in an ED 110, a function of the apparatus 350 may be implemented by one or more processors. Specifically, the processor may include a modem chip, or a system on chip SoC chip or an SIP chip that includes a modem core. A function of the communication unit 353 may be implemented by a transceiver circuit.

In some implementations, when the apparatus 350 is a circuit or a chip that is responsible for a communication function in an ED 110, for example, a modem chip, a system on chip SoC chip or an SIP chip that includes a modem core, a function of the processing unit 352 may be implemented by a circuit system that is in the chip and that includes one or more processors or processor cores. A function of the communication unit 353 may be implemented by an interface circuit or a data transceiver circuit on the foregoing chip.

It may be understood that division into the units in the foregoing apparatus is merely logical function division. Each function may correspond to one functional unit, or two or more functions may be integrated into one functional unit. In actual implementation, all or some of the units may be integrated into one physical entity, or may be distributed in different physical entities. In addition, the foregoing functional units may be implemented in a form of hardware, may be implemented in a form of software, or may be implemented in a form of a combination of hardware and software. Whether a function is performed in a form of hardware or software depends on particular applications and design constraint conditions of the technical solutions. A person skilled in the art may use different methods to implement the described functions for each particular application, but it should not be considered that the implementation goes beyond the scope of this application.

In an example, a functional unit in any one of the foregoing apparatuses may be configured as one or more integrated circuits for implementing the foregoing methods, for example, one or more application-specific integrated circuits (application-specific integrated circuits, ASICs), one or more central processing units (central processing units, CPUs), one or more microprocessors (microcontroller units, MCUs), one or more digital signal processors (digital signal processors, DSP), one or more field programmable gate arrays (field programmable gate arrays, FPGAs), or a combination of at least two of these integrated circuit forms.

In an example, the storage unit 351 may include a random access memory, a flash memory, a read-only memory, a programmable read-only memory, an electrically erasable programmable memory, and/or a register.

A processor, a processor system, an application processor, a baseband processor, a processor circuit, or a processor core may be collectively referred to as a processor. The processor may include one or a combination of a central processing unit (CPU), a digital signal processor (DSP), a microprocessor (microprocessor unit, MPU), a microcontroller (microcontroller unit, MCU), a graphics processing unit (GPU), a field programmable gate array (FPGA), an artificial intelligence processor (AI processor), or a neural network processing unit (NPU).

Memory or a storage unit may include one or more of the following storage media: a random access memory (RAM), a static random access memory (static RAM, SRAM), a dynamic random access memory (dynamic RAM, DRAM), a phase-change memory (PCM), a resistive random access memory (resistive RAM, ReRAM), a magnetoresistive random access memory (magnetoresistive RAM, MRAM), a ferroelectric random access memory (ferroelectric RAM, FRAM), a cache, a register, a read-only memory (ROM), a flash memory, an erasable programmable read-only memory (erasable programmable ROM, EPROM), a hard disk, and the like. In an example, computer program instructions used to execute embodiments may be stored in a non-volatile memory, for example, at least a part of a memory or storage unit (for example, one or more of a ROM, a flash memory, an EPROM, or a hard disk). When a terminal runs, a part or all of corresponding computer program instructions may be loaded to a memory that has a higher transmission speed with the processor, for example, at least a part of a memory or a storage unit (for example, one or more of a RAM, an SRAM, a DRAM, a PCM, a RERAM, an MRAM, a FRAM, a cache, or a register), so that the processor executes the computer program instructions to perform the steps in the method embodiments disclosed herein.

A terrestrial communication system may also be referred to as a land-based or ground-based communication system, although a terrestrial communication system can also, or instead, be implemented on or in water. A wireless communications system may support communications between a UE and non-terrestrial devices, which is also called as a non-terrestrial communication system. The non-terrestrial communication system may bridge the coverage gaps for underserved areas by extending the coverage of cellular networks through non-terrestrial nodes, which will be key to ensuring global seamless coverage and providing mobile broadband services to unserved/underserved regions, in this case, it is hardly possible to implement terrestrial access-points/base-stations infrastructure in the areas like oceans, mountains, forests, or other remote areas.

The terrestrial communication system may be a wireless communications using 5G technology and/or later generation wireless technology (e.g., 6G or later). In some examples, the terrestrial communication system may also accommodate some legacy wireless technology (e.g., 3G or 4G wireless technology). The non-terrestrial communication system may be a communications using the satellite constellations like conventional Geo-Stationary Orbit (GEO) satellites which utilizing broadcast public/popular contents to a local server, Low earth orbit (LEO) satellites establishing a better balance between large coverage area and propagation path-loss/delay, stabilize satellites in very low earth orbits (VLEO) enabling technologies substantially reducing the costs for launching satellites to lower orbits, high altitude platforms (HAPs) providing a low path-loss air interface for the users with limited power budget, or Unmanned Aerial Vehicles (UAVs) (or unmanned aerial system (UAS)) achieving a dense deployment since their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs coupled to integrate satellite communications to cellular networks emerging 3D vertical networks consist of many moving (other than geostationary satellites) and high altitude access points such as UAVs, HAPs and VLEOs.

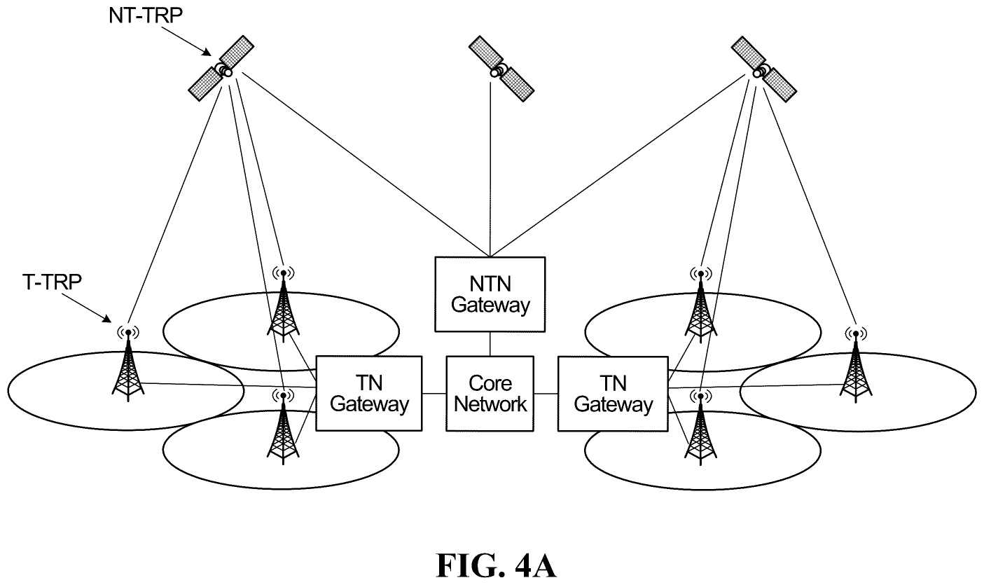

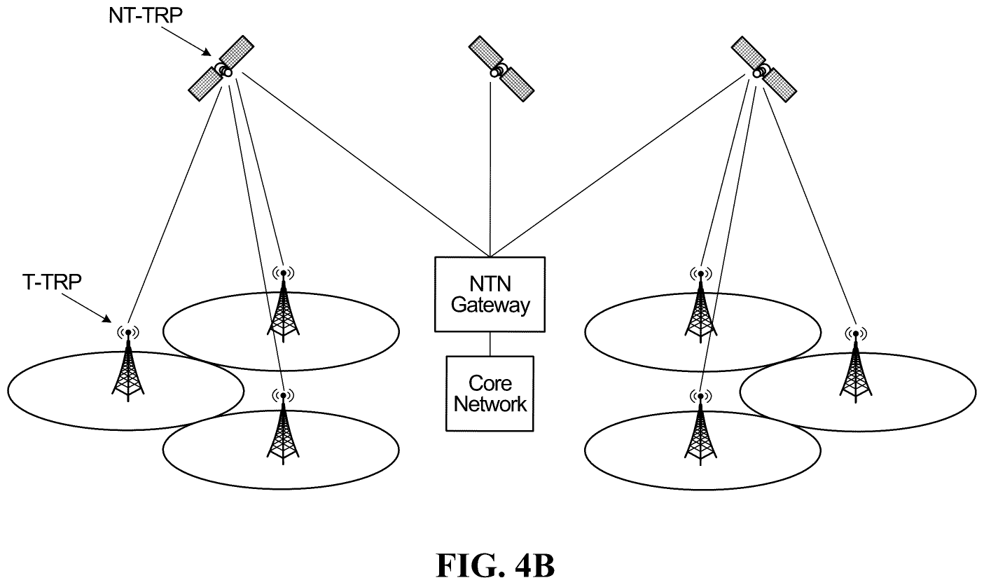

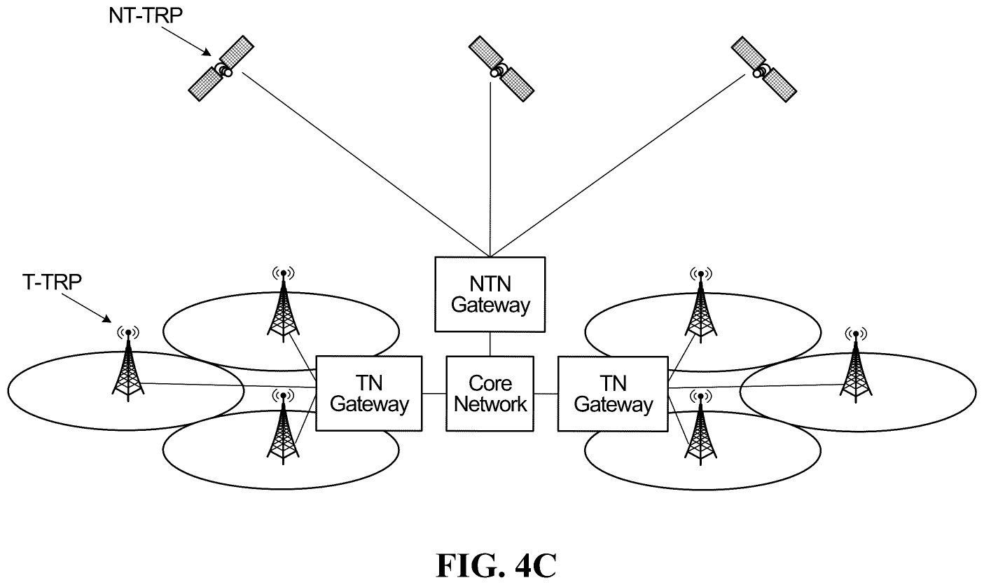

One possible scenario is that T-TRPs are communicating with NT-TRPs that are part of a satellite constellation, see an example shown in FIG. 4A. A satellite constellation comprises a plurality of satellite orbits such that Earth is always provided with wireless coverage from the satellites, and each satellite orbit may have a plurality of satellites in it. T-TRPs may be connected to the core network through terrestrial gateways while satellite constellations may be connected to the core network through dedicated non-terrestrial gateways. Devices such as UEs may connect and communicate with a T-TRP or with an NT-TRP, depending on the conditions of traffic load, radio link quality, congestion, and so on.

Another possible scenario may be envisioned where the satellite constellation effectively acts as the gateway for T-TRPs on the ground, see an example shown in FIG. 4B. Satellites in the satellite constellation communicate with the CN through gateways located on the ground using a wireless link, while the gateways on the ground may use a wired link (e.g. fiber optical link) to communicate with the CN. T-TRPs communicate with satellites using a wireless link and satellites communicate between each-other using free space optical links (using e.g. lasers). Devices such as UEs may connect and communicate with a T-TRP or with an NT-TRP, depending on the conditions of traffic load, radio link quality, congestion, and so on.

Another possible scenario may be envisioned where the NT-TRPs communicate with T-TRPs through the CN, see an example shown in FIG. 4C. NT-TRPs may first communicate with dedicated non-terrestrial gateways, which then communicate with the CN. The CN may then relay information from NT-TRPs to T-TRPs via dedicated terrestrial gateways. Devices such as UEs may connect and communicate with a T-TRP or with an NT-TRP, depending on the conditions of traffic load, radio link quality, congestion, and so on.

In the scenarios above, the link between the UE and the NT-TRPs may be called a service link, and the link between the NT-TRPs and the NTN gateway may be called a feeder link. In addition, the link between the NTN-TRPs may be called as inter-satellite link (ISL) (not shown in the figure). Each NTN-TRP may be associated with one or more NTN Gateways.

Having considered communications more generally above, attention will now turn to particular example embodiments.

Some embodiments disclosed herein enable tree building to be adjusted to network topography. Approaches in which a tree spans in all directions around a root are not always ideal. As an example, when a Ground Station is on a coast, there may be many Ground Stations on land behind the Ground Station on the coast, in which case flooding uniformly around the coast based Ground Station is wasteful. Rather, in this scenario it may be more useful if the coastal Ground Station were to flood away from the coast but to a larger radius. In this manner, the total work done by each other node (such as satellites) that receives a flood message is the same as in the case of flooding in all directions, but that work is concentrated where it has the most benefit. In this example, the most benefit may be provided by sparse Ground Stations over the water, and this is where the work associated with flooding for tree building is concentrated.

Regarding routing, there may be no way for packets beyond the extent of a tree to be routed. Similarly, there may be no way for a packet outside of a flooded region to ever reach a Gateway. Some embodiments herein may help alleviate or avoid these issues. For example, a Gateway/Root ID may be a form of geographic address. In other words, the ID can be directly mapped to a location on the surface of the earth (or other body). Non-limiting examples include latitude/longitude, positions in R3, and so on. With such an ID, geographic routing (forward to a neighbor closest to the ID) can be used, instead of larger forwarding table entries, for packets that are to be routed to a Gateway. This would allow these packets to make their way closer to the Gateway, and eventually they should encounter the edge of a flooded tree and be able to be forwarded normally from that point onward. Such a solution can greatly enhance the usefulness of a limited flood radius and allow for a flood radius to be smaller without sacrificing connectivity, while at the same time reducing the power and load expended by nodes such as satellites for the purpose of flooding control messages for tree building.

The following terms may be used herein:

L2: Layer 2, usually the MAC or non-IP layer just below the IP layer.

Walker Delta: A type of satellite orbit constellation in which the satellites orbit in a mostly polar path but with an inclination less than 90 degrees to the equator. Each orbit has a number of satellites and there are a number of orbits all at the same inclination.

LEO: Low Earth Orbit, usually less than 1000 km, as distinct from Geostationary orbits (GEO) 36,000 km or Medium Orbits (in between LEO and GEO).

LEO Satellites: Low earth orbit satellites, usually 500-1000 km above the surface of the earth in polar inclined orbits of the Walker-Delta variety. The satellites possess up/down links to communicate with Ground Stations and User Terminals. The satellites also possess Inter Satellite Links to allow for relay of packets between adjacent satellites to create an end to end path between a User Terminal and a Ground Station.

Route/Routing: The act of finding a set of intermediate nodes, such as satellites, to follow to get from a source to a destination address based on a set of constraints. For example, packets that follow ISL links may be encapsulated in an appropriate L2 or L2.5 technology to follow a tree. This L2 or L2.5 technology could be MPLS or another technology, such as a proprietary or standards-based L2 or L2.5 encapsulation/forwarding technology.

Root: A root is distinct from a route, and is the root of a tree. A root is the origin of flooded messages which reach out from that root so that nodes (such as satellites and Terminals) can compute routes back to that root. The root of a tree can be thought of as the trunk of a tree from which branches reach upwards, and fork until they terminate at the leaves. Movement from a leaf to the root is unambiguous, as there is only one choice at each branch point to transition toward the root. However, in moving from root to leaf, a decision must be made at each branch point, based on the identity of the leaf.

User Terminal: A device capable of communicating with a LEO Satellite via up/down links and which is then connected to a Ground station via a tunnel traversing one or more LEO satellites via ISL links and a downlink.

ISL: Inter Satellite Link. ISLs are typically radio frequency (RF) or optical (radio/light) free space physical layer connections, between nearby satellites, over which data can be relayed once encapsulated in a suitable tunneling technology.

Ground Station: A special kind of Terminal which also has internet connectivity. User Terminals are connected to Ground Stations via a tunnel (because they are trying to get Internet connectivity) which is formed over a properly routed set of Inter Satellite Links. The Ground Station faces the public Internet, or may potentially face a private IP addressed network, at an IP address range (subnet). The Ground station may allocate addresses within that range/subnet to User Terminals, or it may act as a Network Address Translation (NAT) device, in which case the Ground station allocates private IP addresses to the Terminals and maps from private to public address(es) and User Datagram Protocol/Transmission Control Protocol (UDP/TCP) ports according to the normal NAT function. Such behavior is similar to a home Wifi Router/gateway or a Cellular packet gateway, both of which usually perform NAT between the public internet and the private network they create.

MPLS: Multi Protocol Label Switching (a method of forwarding data along a path). MPLS is a tunneling technology which allows the routing of packets along a path without using IP. It is commonly referred to as an L2.5 technology because it is below Layer 3 (IP) but usually above the MAC layer (L2) of a physical layer interface (L1/L0). MPLS is a suitable (but not the only suitable) tunneling technology to forward packets along trees from a leaf (Terminals) to a Gateway (Roots), for example.

Some embodiments herein relate to directed flooding in a communication network to build routing trees. Directed flooding may also be referred to as, for example, directed routing tree building, restricted flooding or restricted routing tree building, focused flooding or focused routing tree building, limited flooding or limited routing tree building, aimed flooding or aimed routing tree building, or biased flooding or biased routing tree building. Although directed flooding is primarily used herein, other terminology is also possible. Embodiments herein are not limited to any particular name.

Directed flooding refers to an approach to routing tree building in which there are restrictions on distribution and/or processing of flooding messages by network nodes. A restriction may apply to transmitting flooding messages, processing flooding messages, or both. In general, a restriction that is associated with a flooding message for building a network tree may be applied or enforced at a transmitting network node that transmits the flooding message, at a receiving network node that receives the flooding messages, or at both a transmitting network node and a receiving network node.

Examples of directed flooding, and other features that may also or instead be provided in some embodiments, are described in further detail below.

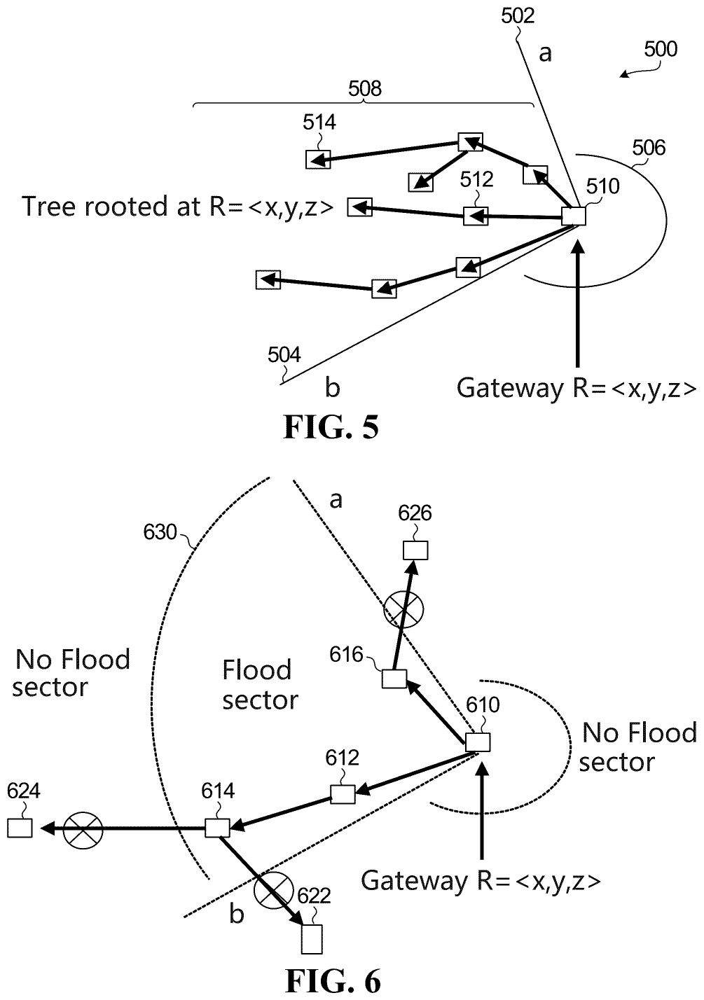

FIG. 5 illustrates directed flooding to build a routing tree according to an embodiment. In FIG. 5, 500 generally designates a communication network. 502 and 504 designate angles a and b, 506 designates an exclusion zone for routing tree building in the example shown, and 508 designates an inclusion zone that is included for routing tree building in this example. A gateway 510 is shown as an example of a network node that may be the root node of a routing tree. The example in FIG. 5 also includes intermediate nodes, one of which is labelled 512, and leaf nodes, one of which is labelled 514. Not all of the network nodes are labelled in FIG. 5, to avoid further congestion in the drawing. The arrows in FIG. 5 represent distribution of flooding messages for building the rooting tree. Such distribution of flooding messages may also be referred to as flooding, for example.

A communication network may also include other network nodes that are not shown in FIG. 5, such as network nodes within the exclusion zone 506 and/or network nodes within the inclusion zone 508 but are not included in a routing tree due to pruning of loops or avoiding longer paths, for example. Embodiments herein are not in any way restricted to the example shown in FIG. 5, or to any particular number of network nodes or any particular network topology.

Although reference is made herein to inclusion zones and exclusion zones, these are intended as general terms to convey the notion of zones that are or are not, respectively, covered by a routing tree that is built from directed flooding. Flooding messages may potentially be distributed outside an inclusion zone and into an exclusion zone, such as in embodiments in which a receiving network node enforces a flooding message restriction and discards a received flooding message for which the receiving network node is not within the inclusion zone. However, even in such embodiments, a receiving network node that is not within the inclusion zone does not further distribute a received flooding message.

Inclusion zones and exclusion zones may be called by other names, such as included/excluded zones, permitted/restricted zones, permitted/limited zones, or flooding/non-flooding zones. The term zone is also intended to be non-limiting, and a zone may be referred to as an area, part, portion, sector, or section, for example.

FIG. 5 illustrates a general example in the context of building a routing tree rooted at R and bounded by angles a and b. In some embodiments, distance to the root network node at R may also be taken into account in building the routing tree.

In the example shown, no tree is built in the clockwise range between angles a-b, relative to R. Such angles may be relative to a reference or datum such as a true north. For example, a routing tree may be built away from a coastline where there are no other gateways, in which case the angles a-b are selected such that the coastline and adjacent land area are at least partially within the exclusion zone 506.

The angles a and b in FIG. 5 represent an example of a restriction in accordance with which network nodes handle a flooding message that is used for routing tree building. As an example of flooding message handling according to a restriction and consistent with the example in FIG. 5, during flooding a flooding message (which may also be referred as a tree building message, for example) will be dropped by network nodes that receive the message but are in the exclusion zone 506, or equivalently are not within the inclusion zone 508. The exclusion zone 506 and the inclusion zone 508 are defined by the angles a and b relative to the root network node 510, and a reference such as a datum line. This is one example of message handling according to a restriction, and others are also provided herein.

FIG. 6 illustrates another example of directed flooding to build a routing tree. A root network node is shown at 610, network nodes within a flood sector are shown at 612, 614, 616, and network nodes outside the flood sector (in a no-flood sector) are shown at 622, 624, 626. The flood sector and no-flood sector in FIG. 6 represent another example of terminology that may be used to describe an inclusion zone and an exclusion zone, respectively.

As described above with reference to FIG. 5, zones may be defined by angles relative to the root network node, and distance to the root network node 610 at R may also be taken into account. In FIG. 6, 630 denotes a distance from the root network node 610 that further defines the flood sector. A restriction associated with a flooding message in FIG. 6 is based on angles and a distance relative to the root network node 610.

When used herein in the context of embodiments or examples, “distance” refers to physical distance or geographic distance, rather than a routing path distance or number of hops, for example.

At a receiving network node that receives a flooding message, determining whether the flooding message restriction is met may involve computing a heading and distance between an originating node (the root network node 610 in this example) and the receiving node, and handling the flooding message in accordance with the restriction may involve discarding that flooding message if the angle for the heading is not between a prescribed start angle and end angle (a and b in FIG. 6) or if the distance metric exceeds a maximum distance metric limit (denoted 630 in FIG. 6).

The angles and distance metric limit may be indicated in the received flooding message and thus may be determined at the receiving network node by obtaining them from the received flooding message, or may be pre-configured and determined at the receiving network node by obtaining them from a configuration. These options for determining a restriction associated with a flooding message apply more generally, and are not in any way limited to restrictions that are based on angles and/or distance.

Flooding in FIG. 6 involves the root network node 610 transmitting a flooding message (possibly after inserting an indication of the angle/distance restriction) to its neighbor nodes 612, 616. The root network node 610 may also transmit the flooding message to other neighbor nodes, but only those within the flood sector are shown in FIG. 6.

At network nodes 612, 616, the angle/distance restriction is determined, by obtaining the restriction from the flooding message received from the root network node 610 or from a configuration for example, and handling of the received flooding message is in accordance with the restriction. Based on computing a heading and distance and determining whether the heading and distance are within respective limits (between angles a and b and distance less than 630), the flooding message may be discarded, or processed and transmitted. In the case of network nodes 612 and 616, the received flooding message is processed and then transmitted to other network nodes 614 (from the network node 612) and 626 (from the network node 616).

The restriction determination and handling are repeated at the receiving network nodes 614 and 626. The network node 626 processes and transmits the flooding message to the network nodes 622 and 624, but is discarded by the network node 626, which is outside the flood sector and is in the no-flood sector.

Finally, in this example, the flooding message transmitted from the network node 614 is received by the network nodes 622, 624, which are outside the flood sector and therefore handling of the flooding message by these network nodes involves discarding the flooding message.

The following pseudocode examples illustrate how a determination may be made as to meeting a restriction that is based on distance and heading, consistent with the example shown in FIG. 6. The first example relates to a distance metric, and the second example relates to a heading.
If (distanceMetric(message.<Rx,Ry,Rz)>, self)> message.maxDistanceMetric) message.discard ( )
If (not inRange(message.a, message.b, heading (message.<Rx,Ry,Rz)>, self)) message.discard ( )

The foregoing are examples only, and embodiments herein are in no way restricted to these examples.

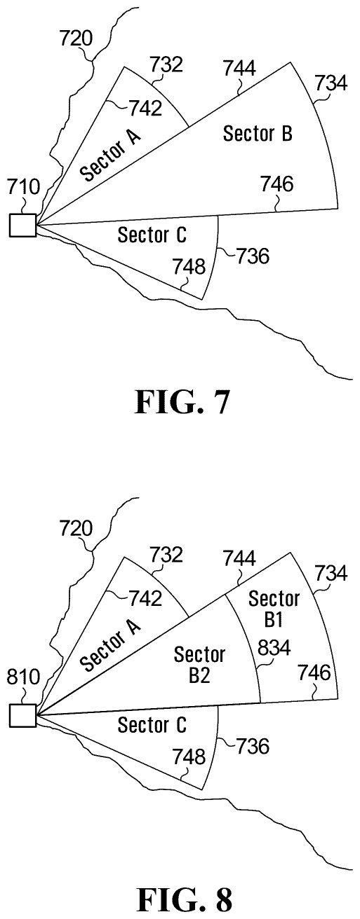

FIG. 7 illustrates a directed flooding example with multiple flood sectors. The preceding examples in FIGS. 5 and 6 include one inclusion zone or flood sector and one exclusion zone or no-flood sector. The example in FIG. 7 includes three flood sectors A, B, and C, for directed flooding to build a routing tree that is rooted from a root network node 710 on a coastline 720, away from land on which the root network node is located. In order to avoid further congestion in the drawing, other network nodes are not shown in FIG. 7.

Sector A in FIG. 7 is defined by angles 742 and 744, and distance limit 732; sector B is defined by angles 744 and 746, and distance limit 734; and sector C is defined by angles 746 and 748, and distance limit 736. Angle spread or “width” of different sectors may be the same or different. Although distance limits may be the same or different for different sectors. it is expected that at least adjacent sectors defined by angles and distance limits will have different distance limits.

In a coastline example as shown in FIG. 7, there are typically plenty of gateways on land, and not as much need for multi-hop routing relative to areas over water, where there may be no (or at least fewer) gateways and a greater need for multi-hop routing to reach land gateways.

The example in FIG. 7 is illustrative of an embodiment in which multiple sectors are defined, and a flooding message (or configuration for example) may contain multiple sector definitions in terms of bounding angles and distances. As in other embodiments, flood messages may be discarded if received at network nodes that are not in any of the flood sectors. This permits routing tree building in multiple directions of different distances, for example.

FIG. 8 illustrates another directed flooding example with multiple flood sectors. The example in FIG. 8 is substantially the same as the example in FIG. 7, with the exception that sector B, or equivalently a flooding message restriction, is variable between sector B1 and sector B2. The root network node 810 is designated by a different reference number in FIG. 8 to reflect its ability to support variable sectors or flooding message restrictions. Sector or flooding message restriction variations may be based on or dependent upon any of various parameters, such as time and/or load. For example, sector or flooding message restriction variation may be time-based (which may also be referred to as time-dependent, or as a function of time), load-based (which may also be referred to as load-dependent, or as a function of load), or both.

In the illustrated coastline example with the root network node 810 in a coastal area, there may be no (or fewer) boats on the water at night, and sector B1, or equivalently a flooding message restriction for sector B1, may be used at such times to extend the reach of a routing tree to service more terminals. This is an example of time-based sector or flooding message restriction variation.

With fewer boats on the water, whether at night or otherwise, load may be lower, and more generally under lightly loaded conditions sector B1, or equivalently a flooding message restriction for sector B1, may be used, again to extend the reach of a routing tree to service more terminals. This is an example of load-based sector or flooding message restriction variation. With a load or loading threshold denoted C, sector B2, or equivalently a flooding message restriction for sector B2, with lower distance limit 834 may be active under higher or heavier loading (F(load)≥C), and sector B1, or equivalently a flooding message restriction for sector B1, with higher distance limit 734 may be active under lower or lighter loading (F (load)<C).

In another embodiment, sector or flooding message restriction variation is based on multiple parameters, such as both time and load.

The example in FIG. 8 illustrates different distance limits 734 and 834 associated with sector B1 and sector B2, respectively. The angles defining these sectors may be the same (744 and 746) or different. Sector variations may involve variations in one or more parameters, including distance limits and/or one or both angles in the example shown in FIG. 8.

FIG. 8 is illustrative of an embodiment in which a variable sector or flooding message restriction (or multiple variable sectors or flooding message restrictions) may be defined, and a flooding message (or configuration for example) may contain multiple sector definitions or flooding message restrictions, in terms of bounding angles and distances in the example shown. The sector definitions or flooding message restrictions, including angles and distance limits such as radius limits, are a function of one or more parameters, such as a function of time, a function of network load, or a function of both time and network load.

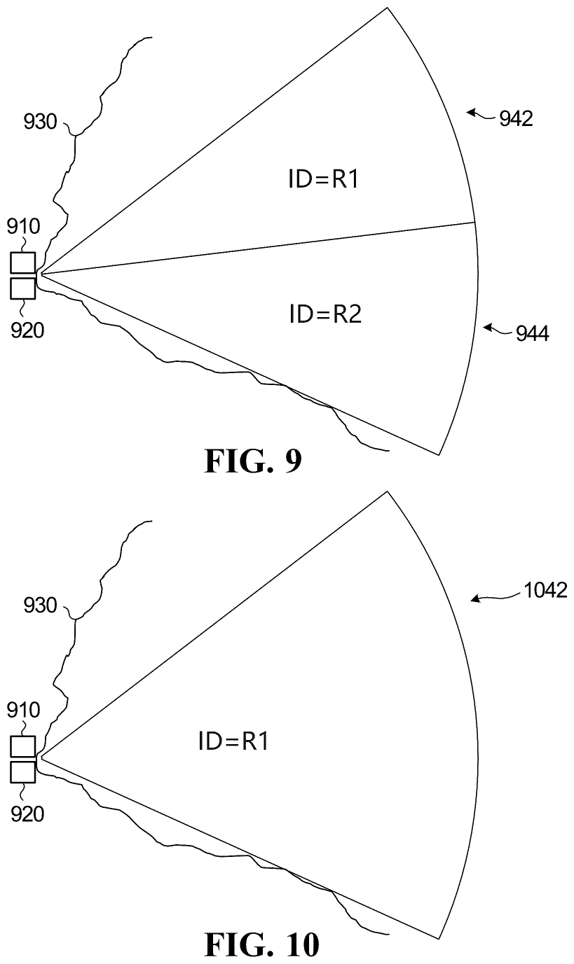

FIG. 9 illustrates a directed flooding example for two adjacent ground stations, and FIG. 10 illustrates a directed flooding example in which one of the ground stations in FIG. 9 takes over the flood sector of the other. In FIGS. 9 and 10, two nearby ground stations 910, 920 are located on a coastline 930. Each ground station 910 and 920 conducts directed flooding to build a respective routing tree, and a respective flood sector associated with each ground station is shown in FIGS. 9 at 942 and 944. R1 and R2 in FIG. 9 are identifiers of the ground stations 910 and 920, respectively.

FIG. 10 illustrates a change in the flood sector, or equivalently a revised flooding message restriction, for the ground station 910 (ID=R1). The flood sector 1042 is expanded relative to the flood sector 942 as a result of the revised flooding message restriction, to encompass the flood sector 944. For example, under normal operating conditions each ground station 910 and 920 may cover a different sector 942 and 944, respectively, but the sector, or equivalently a flooding message restriction, associated with one of the ground stations (910 in the example shown in FIG. 10) may change if the other ground station (920 in the example shown in FIG. 10) fails or an operating condition such as loading changes. After failure, for example, one ground station can, in effect, take over both sectors, or more generally one or more flooding message restrictions may be revised so that one network node may take over a sector from one or more other network nodes.

FIG. 10 is illustrative of an embodiment in which a variable sector, or equivalently a flooding message restriction, (or multiple variable sectors or flooding message restrictions) may be defined, and a flooding message (or configuration for example) may contain multiple sector definitions or flooding message restrictions, in terms of bounding angles and distances in the example shown. The multiple sector definitions or flooding message restrictions may define a base or normal sector for a network node, and one or more expanded sectors that encompass the sector(s) of one or more nearby network nodes such as nearby ground stations. The expanded sector(s) or flooding message restriction(s) may become active depending on status of the nearby network node(s). If a nearby ground station goes offline, fails, or is too heavily loaded, for example, then it can hand over all or part of its sector to another ground station. The two ground stations in this example can communicate with each other directly, such as by messaging directly via terrestrial internet for example, to exchange this information related to flood sector handover and agree to sector boundaries between themselves. Another possible option involves flood sector hand over being preconfigured, prior to a failure or other status change responsive to which a flood sector is handed over or taken over between different network nodes.

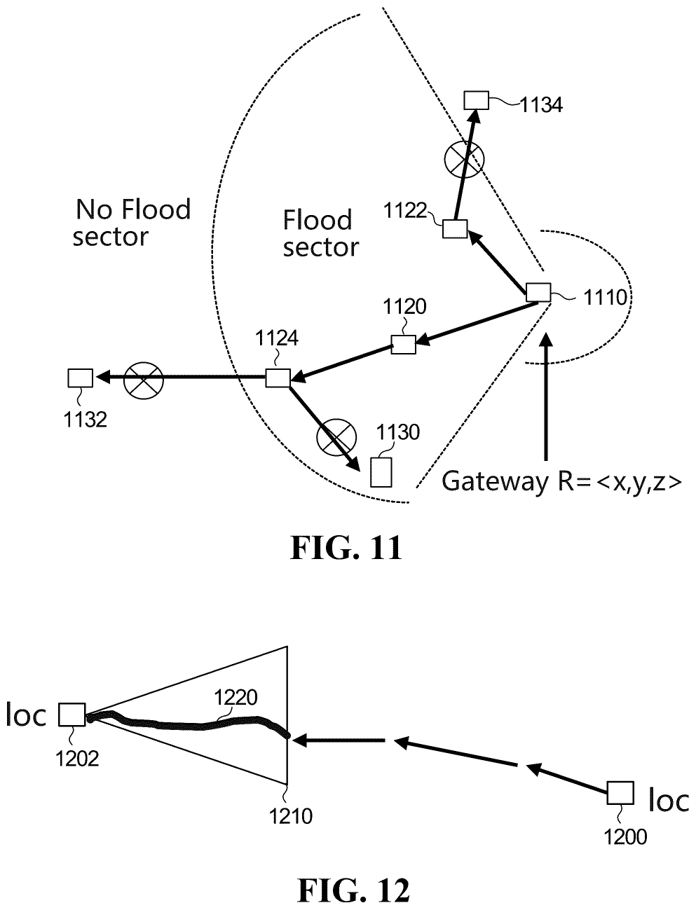

FIG. 11 illustrates another example of directed flooding to build a routing tree according to an embodiment. In FIG. 11, a flood sector and a no-flood sector are partially defined by two angles relative to a root network node 1110 and a limit of distance from the root network node. As described in further detail below, flooding message handling is also based on network node identity in this example.

Flooding message handling in FIG. 11 is somewhat similar to the flooding message handling in FIG. 5. During flooding, a flooding message may be dropped by network nodes that receive the message but are in the no-flood sector, or equivalently are not within the flood sector. However, this is only one part of determining whether a flooding message restriction is met in FIG. 11. The flooding message restriction in this example is further based on network node identity. For example, a set or list of network node identities, such as node identifiers, may include the identities of nodes that are to be excluded from routing trec building. A receiving node that receives a flooding message may then further determine whether its identity is in the exclusion set, and if so, the flooding message may be dropped. More generally, in order to fully meet the restriction in this example, a network node must be within the flood sector and also must not be in the exclusion set.

The flooding in FIG. 11 involves the root network node 1110 transmitting a flooding message to its neighbor nodes 1120 and 1122. At these network nodes 1120 and 1122, the angle/distance/identity restriction is determined, by obtaining the restriction from the flooding message received from the root network node 1110 or from a configuration for example, and handling of the received flooding message is in accordance with the restriction. Based on whether the receiving network node is within the angle and distance range of the flood sector and whether the receiving network node is in the exclusion set, the flooding message may be discarded, or processed and transmitted, for example. In the case of network nodes 1120 and 1122, the received flooding message is processed and then transmitted to other network nodes 1124 (from the network node 1120) and 1134 (from the network node 1122).

The restriction determination and handling are repeated at the receiving network nodes 1124 and 1134. The network node 1124 processes and transmits the flooding message to the network nodes 1130 and 1132. The flooding message is discarded by the network node 1134, which is outside the flood sector and is in the no-flood sector.

Finally, in this example, the flooding message transmitted from the network node 1124 is received by the network nodes 1130 and 1132. The network node 1132 is outside the flood sector and therefore handling of the flooding message by this network node involves discarding the flooding message. Although the network node 1130 is inside the flood sector, in the example shown handling of the flooding message by this network node involves discarding the flooding message because the network node is in the exclusion set.

FIG. 11 represents an example in which directed flooding and a flooding message restriction is based on multiple different types of parameters, including spatial parameters (angles and distance) and network node identity. These parameters may be used together as in this example, in a different combination, or independently.

For instance, the following pseudocode examples illustrate how a determination may be made as to meeting a restriction that is based on distance and an exclusion set. The first example relates to a distance metric, and the second example relates to a an exclusion set (message.exclusions).
If (distanceMetric(message.<Rx,Ry,Rz)>, self)> message.maxDistanceMetric) message.discard ( )
If (elementOf(message.exclusions, self)) message.discard ( )

These examples, like others herein, are examples only. Embodiments are in no way restricted to these examples.

Some embodiments may involve appending to a flood message, otherwise including in a flooding message, or including in a configuration for example, a set or list of exclusion network nodes. When a network node receives a flooding message and that network node is a member of the exclusion set, it does not process the flooding message. Alternatively, the exclusion set can be checked by a network node prior to forwarding a flooding message, and handling of the flooding message avoids transmitting the flooding message to a network node which is contained in the exclusion set.

The origin R, or another network entity, can establish the exclusion set to create any pattern of forwarding zone or flooding zone that is desired, when identities and positions of other network nodes are known.

The examples in FIGS. 5 to 11 relate to directed flooding and routing tree building. In some embodiments, a network node such as the root node of a routing tree may have a network address that is indicative of geographic location of the network node, to enable routing toward the network node from outside the routing tree. This type of addressing may be referred to geographic addressing, and such routing toward a network node from outside a routing tree may be referred to as geographic routing. These features may be implemented in conjunction with routing tree building, or independently. For example, geographic addressing and geographic routing are not in any way depending upon or limited to any particular way of building a routing tree.

With a geographic address for a root network node it is possible to combine geographic routing and routing trees, with reverse learning for example. For geographic routing by a network node that is outside a routing tree, forwarding can involve forwarding to a closest neighbor in the direction of the destination node that has a geographic address, when the path to the destination network node is not known. In this case the routing tree has been built out to some flood region distance, but geographic addressing and geographic routing can provide for routing to a destination network node from outside that flood region distance.

Geographic addressing and geographic routing may involve, for example, a geographic address that is based on latitude and longitude, coordinates such as x,y,z coordinates, spherical coordinates, or other coordinates, or some other form of position indicator. In FIGS. 5, 6, and 11, the root network node is illustrated as having a geographic address based on <x, y, z> coordinates. This is one example of a geographic address, and embodiments are not in any way limited to this type of geographic address, or to geographic addressing in conjunction with routing tree building consistent with the examples in these drawings.

FIG. 12 illustrates an example of geographic routing, in the context of a network node 1200 at a location outside a routing tree 1210 that is rooted at a root network node 1202. The root network node 1202 has a geographic address that is indicative of its location, and based on that address the network node 1200 can perform routing by forwarding a packet to one or more of its neighbors that are located in a direction toward the location of the root network node. Geographic routing is illustrated in FIG. 12 by the arrows between the network node 1200 and the routing tree 1210. Each arrow is intended to represent routing at a network node that is outside the routing tree 1210. These network nodes are not explicitly shown in FIG. 12 to avoid congestion in the drawing.

A geographically routed packet may eventually reach a network node that is part of the routing tree 1210, and then tree-based routing can be used to route the packet to the root 1202 in this example. In FIG. 12, 1220 represents tree-based routing.

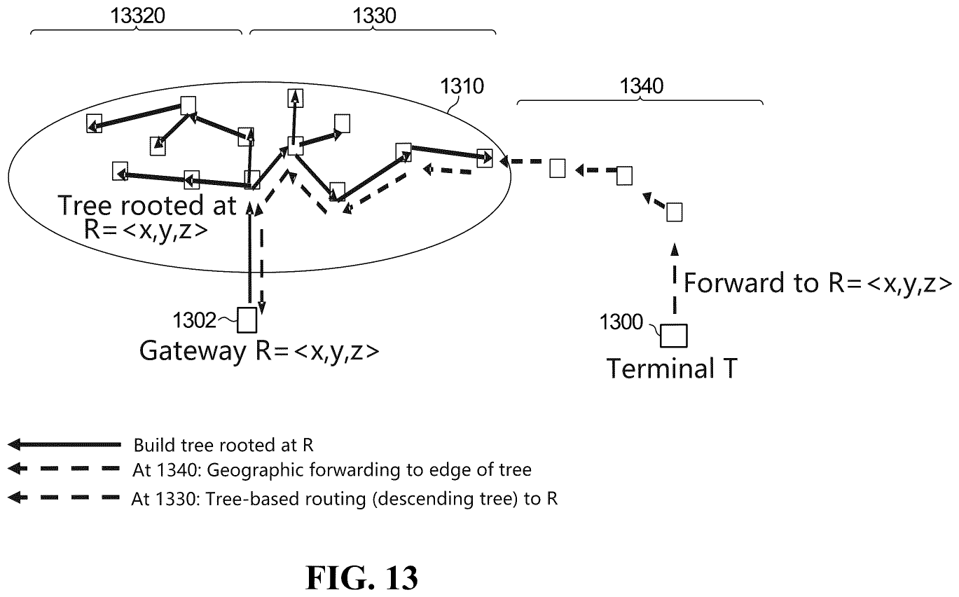

FIG. 13 illustrates a more detailed example of geographic routing. In FIG. 13, solid arrows represent tree building to build a routing tree 1310 rooted at a gateway 1302, which has a geographic address to enable geographic routing outside the routing tree.

Geographic routing is referenced in FIG. 13 as geographic forwarding at 1340, from a terminal T at 1300 to an edge of the routing tree 1310. At 1330, FIG. 13 illustrates tree-based routing to the gateway 1302, which may also be referred to as descending the routing tree 1310.

FIGS. 12 and 13 are illustrative of embodiments in which routing may involve both geographic routing for part of a path outside a routing tree and tree-based routing for a remainder of the path between network nodes within the routing tree. The illustrated embodiments use a geographic address as the root of a routing tree, but more generally routing within a routing tree and thus geographic addressing need not necessarily be restricted only to the root network node of a routing tree.

In embodiments that involve tree-based routing and geographic routing, the tree-based routing may involve descending a routing tree using the destination address (without considering locations of neighbor network nodes) but using the locations of neighbor network nodes and in particular proximity to (distance from) the destination for geographic routing outside the tree. For the geographic routing in this example, the proximity of neighbors to the destination may be used to get closer to the tree.

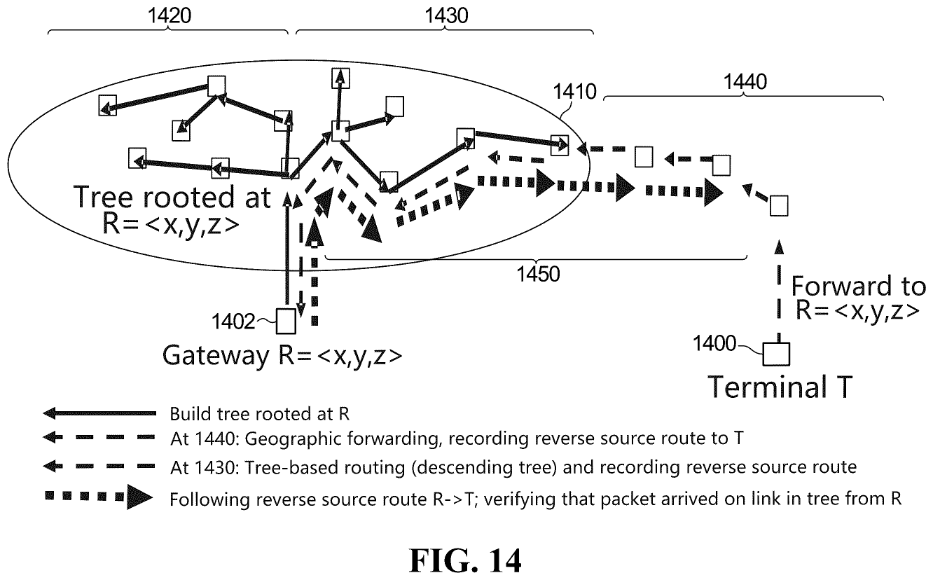

FIG. 14 illustrates an example of reverse source route checking, which may be implemented in conjunction with other features herein, or independently. In FIG. 14, solid arrows represent tree building to build a routing tree 1410 rooted at a gateway 1402, which has a geographic address to enable geographic routing outside the routing tree. Routing tree building in FIG. 14 may be the same as in the example in FIG. 13.

Geographic routing is referenced in FIG. 14 as geographic forwarding at 1440, from a terminal T at 1400 to an edge of the routing tree 1410, and also involves recording a reverse source route to T in the example shown.

At 1430, FIG. 14 illustrates tree-based routing, which may also be referred to as descending the routing tree 1410, and recording a reverse source route to terminal T.

The example shown in FIG. 14 also includes following a reverse source route from R to T, and verifying (at terminal T) that a routed packet arrived on a link in the tree from R.

FIG. 14 is illustrative of an example that involves, while following a reverse source/segment route from R to T, verifying that the segment route corresponds to the tree back to R as long as the tree back to R exists. This may also be described as limiting a source route check to within a routing tree, such that a reverse source route check is within the scope of the routing tree. Normally for a terminal T outside the routing tree 1410 as in the example shown, reverse source routing would be considered a failure because there is no routing information in the routing tree for terminal T, but according to an aspect of the present disclosure a reverse source route check from R to T may involve verifying the part of the route outside the routing tree based on increasing distance from R at each hop (at 1440) outside the routing tree, for example.

Various embodiments are disclosed by way of example above.

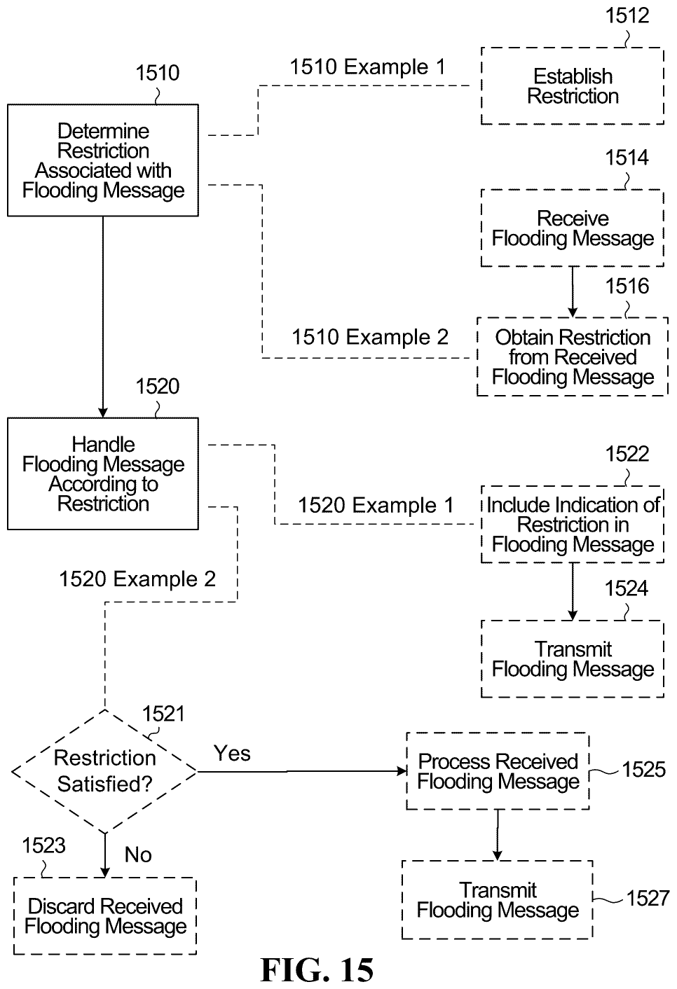

FIG. 15 includes flow diagrams illustrating general example methods according to embodiments.

At 1510 and 1520, FIG. 15 illustrates operations or features that may be provided or supported at network devices according to an embodiment, and FIG. 15 also illustrates several non-limiting examples of each of those operations or features.

According to an aspect of the present disclosure, a method may involve determining, at a network node in a communication network, a restriction associated with a flooding message for building a routing tree in the communication network. This is shown in FIG. 15 at 1510. As shown at 1520, such a method may also involve handling the flooding message, at the network node, according to the restriction. Examples of ways to determine a restriction, examples of types of restrictions, and examples of handling a flooding message according to a restriction are provided herein.

Consider, as an example, a network node such as a root node that may initiate flooding by generating a flooding message. Such a network node may establish a restriction on a flooding message as shown at 1512 as a first example of operation 1510. Thus, determining a restriction associated with a flooding message may involve establishing that restriction. Establishing a restriction may also be referred to as, for example, setting the restriction, creating the restriction, or deciding on the restriction. A restriction controls directed flooding and tree building, and may be established based on a desired shape or pattern for directed flooding.

A flooding message restriction may be established on the basis of any of various criteria or conditions. For example, it may be desired to build a routing tree away from a coastline where there are no other gateways or fewer gateways, and a restriction may be established such that the coastline and adjacent land area are at least partially within an exclusion zone, as described by way of example above in the context of FIG. 5. The examples in FIGS. 7, 8, 9, and 10 also illustrate restrictions to build routing trees away from a coastline 720 and 930. As described with reference to FIG. 11, the exclusion set may be established to create any pattern of forwarding zone or flooding zone that is desired, when identities and positions of other network nodes are known. More generally, a flooding message restriction may be established to create any pattern of forwarding zone or flooding zone (and routing tree coverage) that is desired.

Regarding intermediate network nodes or leaf network nodes, determining a restriction at these nodes may involve obtaining the restriction from a received flooding message in some embodiments. As shown in FIG. 15 as a second example of 1510, a method may involve receiving the flooding message at the network node from another network node (1514), and obtaining the restriction from the received flooding message (1516).

The operations at 1512 and 1516 provide two examples of how a restriction associated with a flooding message may be determined. Other options are possible. For example, a flooding message restriction may be determined at a network node from configuration. Establishing a restriction is not in any way necessarily restricted to a root network node. A restriction may be established and distributed, to a root network node and/or other network nodes, in one or more network node configurations. A method may then involve determining the restriction, at a network node, by obtaining the restriction from the network node's configuration.

Turning now to handling the flooding message as shown at 1520, in the case of a network node such as a root network that initiates flooding, this handling may involve including an indication of the restriction in the flooding message as shown at 1522 as a first example of 1520, and transmitting the flooding message as shown at 1524, with the indication included in the flooding message.

The indication may be, for example, an indication of the angles 502 and 504 in FIG. 5, or an indication of the angle/distance restriction (two angles and a distance, for example) in FIG. 6, angles and distances in the examples in FIGS. 7-10, and angles, a distance, and an exclusion list or set in the example in FIG. 11. An indication of a restriction may also or instead be included in a network node configuration, in embodiments in which determining a restriction involves obtaining the restriction from configuration.

The transmitting at 1524 may include transmitting the flooding message to all neighbor network nodes (where the restriction is applied or enforced at a receiving network node that receives the flooding message), or only to one or more other network nodes in the communication network at which the restriction would be satisfied (where the restriction is applied or enforced at a transmitting network node that transmits the flooding message). In some embodiments, a restriction may be applied or enforced at both a transmitting network node that transmits the flooding message and at a receiving network node that receives the flooding message.

As described above in the context of FIG. 5, flooding messages may potentially be distributed outside an inclusion zone and into an exclusion zone, and this is illustrative of an embodiment in which flooding message handling may involve transmitting a flooding message to neighbor network nodes and the receiving network nodes apply a flooding message restriction and discard a received flooding message where the flooding message restriction is not satisfied. Even in such embodiments, a receiving network node at which a flooding message restriction is not satisfied (the network node is not within the inclusion zone, or equivalently is within the exclusion zone in this example) does not further distribute a received flooding message.

Regarding a restriction being satisfied or not satisfied, this may be described as a network node satisfying (or not satisfying) the restriction. The network node may be located outside an inclusion zone or within an exclusion zone and thereby not satisfy a restriction associated with a flooding message. In this example, satisfying or not satisfying the restriction may also be described as the network node location satisfying or not satisfying the restriction. As another example, in the case of a restriction in respect of a number of hops from a root network node, a network node or its position in network topology may be considered as satisfying or not satisfying the restriction. In an embodiment that involves an exclusion set, a network node or its identifier may be considered as satisfying or not satisfying the restriction.

In general, a restriction may be satisfied or not satisfied, and this may be considered as the network node itself satisfying or not satisfying the restriction, or as a feature or characteristic of a network node (such as location or identity, for example) satisfying or not satisfying the restriction. This applies not only to the transmitting at 1524, but also to other features that are dependent upon whether a restriction is satisfied or not satisfied.

Example 2 of 1520 in FIG. 15 relates to a receiving network node that receives a flooding message. In the context of a method that involves receiving a flooding message, handling the received flooding message may involve processing the flooding message as shown at 1525 where the restriction is satisfied, and otherwise discarding (also referred to herein as dropping) the flooding message as shown at 1523. Processing a flooding message may involve, for example, updating distance information in the flooding packet, and/or recording path information in a forwarding table.

FIG. 15 also illustrates determining, at 1521, whether the restriction is satisfied. Thus, a method may involve determining, at a network node that receives a flooding message, whether the restriction associated with the flooding message is satisfied.

As shown at 1527, handling a flooding message may also involve transmitting the flooding message after processing at 1525, where the restriction is satisfied. Transmitting the flooding message after processing, similar to the transmitting at 1524, may involve transmitting the flooding message (including any changes made in the processing at 1525) to neighboring nodes of the network node in the communication network, or transmitting only to one or more of the neighboring nodes at which the restriction is satisfied.

The examples in FIG. 15 are not mutually exclusive. For example, 1510 Example 2 and 1520 Example 2 are both in the context of receiving the flooding message. A method may involve both of these examples, with receiving the flooding message at 1514 and obtaining the restriction from the flooding message at 1516 consistent with 1510 Example 2, and handling the received flooding message consistent with 1520 Example 2. Similarly, a method may involve establishing the restriction at 1512 consistent with 1510 Example 1, and including an indication of the restriction in the flooding message at 1522 and transmitting the flooding message including the restriction indication at 1524 consistent with 1520 Example 1.

Examples of restrictions are provided elsewhere herein. A restriction associated with a flooding message may be or include a restriction based on any one or more of the following, for example:
angles relative to a root node of the routing tree;
a distance from the root node of the routing tree;
a set of network node identities.

FIG. 5 illustrates an example in the context of building a routing tree rooted at R and bounded by angles a and b. This is an example of a restriction based on angles 502 and 504 relative to a root node of the routing tree that is being built. Distance to a root network node may also be taken into account in building a routing tree, as shown by way of example in FIG. 6. The example in FIG. 6 is illustrative of a restriction that is based on angles 502 and 504 relative to a root node and a distance 630 from the root node. The example in FIG. 11 is further based on a set of network node identities, and therefore provides an example of a restriction that is based on angles relative to a root node, a distance from the root node, and a set of network node identities. These examples in FIG. 6 and FIG. 11 (and others herein including those in FIGS. 7 to 10) illustrate directed flooding and a flooding message restriction based on multiple parameters, and in the example in FIG. 11 the restriction is based on different types of parameters including spatial parameters (angles and distance) and network node identity. Parameters may be used together as in these examples, in different combinations, or independently.

A flooding message restriction limits flooding message distribution and processing, and thus routing tree building. In the example shown in FIG. 5, no routing tree is built in the clockwise range between angles a-b, relative to R. Flooding message handling according to a restriction and consistent with the example in FIG. 5 involves dropping (also referred to herein as discarding, at 1523 for example) a flooding message by network nodes at which the flooding message is received but the restriction (location of the network node within the exclusion zone 506, or equivalently are not within the inclusion zone 508) is not satisfied. The determination at 1521 for this example may involve determining whether the network node is within the inclusion zone 508.

As described with reference to FIG. 6, determining whether a flooding message restriction is met may involve computing a heading and distance between an originating node (the root network node 610 in this example) and the receiving node, and this is an example of the determining at 1521 in FIG. 15. Handling the flooding message in accordance with the restriction may involve discarding that flooding message as shown at 1523 if the angle for the heading is not between a prescribed start angle and end angle (a and b in FIG. 6) or if the distance metric exceeds a maximum distance metric limit (denoted 630 in FIG. 6).

Although flooding message handling in FIG. 11 is similar to flooding message handling in FIGS. 5 and 6 in that a flooding message may be dropped by network nodes that receive the message but are in the no-flood sector (or equivalently are not within the flood sector), this is only part of determining whether a flooding message restriction is satisfied in the example in FIG. 11. The flooding message restriction in this example is further based on network node identity, and determining whether the flooding message restriction is satisfied (at 1521 in FIG. 15) further involves determining whether the identity of the network node is in the exclusion set.

In some embodiments, a restriction may be one of multiple restrictions associated with a flooding message. The multiple restrictions may be or include, for example, any one or more of the following:
restrictions based on respective angles relative to a root node of the routing tree;
restrictions based on respective distances from the root node of the routing tree;
restrictions based on respective times;
restrictions based on respective levels of loading in the communication network;
restrictions based on respective sets of network node identities.

FIG. 7 illustrates a directed flooding example with multiple flood sectors, which represents an example of an embodiment in which there are multiple restrictions associated with a flooding message. In the FIG. 7 example, the multiple restrictions include restrictions based on respective angles relative to a root node of the routing tree and respective distances from the root node of the routing tree, for each sector. In the example shown in FIG. 8, the multiple restrictions include restrictions based on respective angles and distances for sectors A and C, and also include restrictions that are further based on respective times and levels of leading, for sectors B1 and B2. Although not explicitly shown in the drawings, multiple restrictions may also include restrictions based on respective sets of network node identities, possibly in combination with one or more other parameters. For example, the restrictions for any of the sectors in FIG. 7 and/or FIG. 8 may also be based on respective sets of network node identities.

In embodiments that involve multiple restrictions, a flooding message (or configuration for example) may contain indications of the multiple restrictions, such as multiple sector definitions in terms of bounding angles and distances in FIG. 7. As in other embodiments, flood messages may be discarded if received at network nodes that are not in any of the flood sectors, or more generally if received at network nodes at which none of the multiple restrictions are satisfied. Similarly, for the example in FIG. 8, with sector B further providing an example of a sector (or restriction) that is variable, a flooding message (or configuration for example) may contain multiple sector definitions or flooding message restrictions, in terms of bounding angles and distances in the example shown. The sector definitions or flooding message restrictions, including angles and distance limits such as radius limits, are a function of one or more parameters, such as a function of time, a function of network load, or a function of both time and network load.

A method may involve other features, instead of or in addition to those shown in FIG. 15.

As an example, a method may involve determining, at a network node, a revised restriction that is based on a restriction associated with a flooding message and a second restriction associated with building a second routing tree in a communication network. Such a method may also involve handling a second flooding message, by the network node, according to the revised restriction.

This is consistent with the example provided above with reference to FIGS. 9 and 10. In FIG. 9, each of the two adjacent ground stations 910 and 920 conducts directed flooding (with respective restrictions for the flood sectors 942 and 944), and FIG. 10 illustrates a directed flooding example in which the ground station 910 takes over the flood sector of the ground station 920.

From the perspective of the ground station 910 in this example, a method may involve determining, at that network node (ground station 910) a revised restriction, that is based on the restriction associated with a flooding message for building a routing tree within the sector 942, and a second restriction associated with building a second routing tree (by another network node, in particular the ground station 920) in the sector 944. In this example, a method may also involve handling, at the ground station 910, a second flooding message for building a routing tree in the expanded sector 1042 according to the revised restriction. The revised restriction changes the flood sector for the ground station 910 from 942 to 1042, and one or more parameters of the restriction (at least one angle in the example shown) are different between the original restriction for the sector 942 and the revised restriction for the sector 1042.

The example provided by FIGS. 9 and 10 illustrates how a revised flooding message restriction may be established, if another network node fails or an operating condition such as loading changes for example, so that one network node may take over a sector and routing tree building from one or more other network nodes.

Thus, a variable sector or flooding message restriction (or multiple variable sectors or flooding message restrictions) may be defined, and a flooding message (or configuration for example) may contain multiple sector definitions or flooding message restrictions, in terms of bounding angles and distances in the example shown in FIGS. 9 and 10. The multiple sector definitions or flooding message restrictions may define a base or normal sector for a network node, and one or more expanded sectors that encompass the sector(s) of one or more nearby network nodes such as nearby ground stations. The expanded sector(s) or flooding message restriction(s) may become active depending on status of the nearby network node(s). If a nearby ground station goes offline, fails, or is too heavily loaded, for example, then it can hand over all or part of its sector to another ground station. The two network nodes in this example can communicate with each other directly, such as by messaging directly via terrestrial internet for example, to exchange information related to flood sector handover and agree to sector boundaries (flooding message restrictions) between themselves. Thus, in an embodiment a method may involve communicating, by a network node with another network node, to exchange information related to a revised flooding message restriction. Another possible option involves flood sector hand over being preconfigured, prior to a failure or other status change responsive to which a flood sector is handed over or taken over between different network nodes based on a network node detecting a change in an operating condition of another network node and obtaining a preconfigured revised flooding message restriction from a network node configuration.

Geographic addressing and routing outside a routing tree are also disclosed herein, and in some embodiments a network node that determines a restriction and handles a flooding message may have an address in the communication network that is indicative of a geographic location of the network node, to enable routing toward the network node from outside the routing tree. In some embodiments, a root network node of a routing tree has such an address, but other routing tree network nodes may also or instead have a geographic address. It should be noted, however, that geographic addressing and geographic routing outside a routing tree are not in any way depending upon or limited to any particular way of building a routing tree.

Geographic address examples are provided herein, and a geographic address may be or include a geographic address based on latitude and longitude, coordinates such as x,y,z coordinates, spherical coordinates, other coordinates, or some other form of position indicator, for example. Embodiments are not in any way limited to any particular type of geographic address.

According to an aspect of the present disclosure, geographic routing may be combined with routing according to routing trees. Routing from a network node that is outside a routing tree may involve routing based on a geographic address of a destination network node (by forwarding to a neighbor network node in the direction of the destination network node for example) a until a packet reaches a network node within the routing tree, and subsequently routing the packet toward the destination node based on the routing tree.

FIGS. 12 to 14 illustrate examples of geographic routing, in which, at a system level, routing involves a combination of geographic routing at one or more network nodes outside a routing tree and tree-based routing at one or more network nodes that are within a routing tree. Embodiments that involve geographic addressing and/or geographic routing may include any of the features shown in these drawings or otherwise disclosed herein.

The present disclosure encompasses various examples, including not only method examples, but also other examples such as apparatus examples and examples related to storage media such as non-transitory computer-readable storage media. Examples may incorporate, individually or in combinations, the features disclosed herein.

An apparatus may include one or more processors configured, by executing instructions or programming for example, to cause the apparatus to perform a method or operations, or to provide or support features, disclosed herein. An apparatus may also include memory or one or more storage media, such as a non-transitory computer readable storage medium. The storage medium or media may be coupled to the processor(s) and store instructions or programming for execution by the processor(s). For example, the processors 210 and 260 in FIG. 3A may each be or include one or more processors and the example apparatus 330 in FIG. 3B may include one or more processors/processor cores 331. Each memory 208 and 258 in FIG. 3A and 333 in FIG. 3B is an example of a storage medium that may be provided in an apparatus. A storage medium need not necessarily be provided only in combination with a processor, and may be provided separately in a computer program product, for example.

As an illustrative example, instructions or programming stored in or on a storage medium may include instructions or programming to, or to cause a processor, an apparatus, or a component thereof to, perform any of the operations or provide any of the features disclosed herein. A processor, device, or other component may otherwise be configured to perform any of the operations or provide any of the features disclosed herein.

Apparatus examples are not limited to the foregoing examples, or to processor-based or programming-based examples. An apparatus may also or instead include, for example, one or more units configured to perform any of the operations or provide any of the features disclosed herein. Examples of such units are provided in FIGS. 3A to 3C including the illustrated components of the example apparatus 310, the example apparatus 320, the example apparatus 330, and the example apparatus 350.

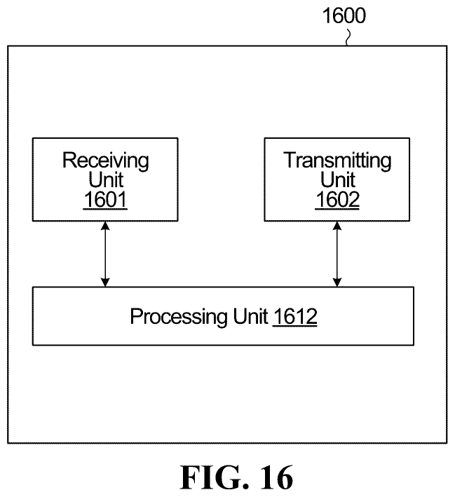

A further example apparatus 1600 is illustrated in FIG. 16, and includes a receiving unit 1601, a transmitting unit 1602, and a processing unit 1612 coupled to the receiving unit and the transmitting unit. The example apparatus 1600 is intended as a general example, to illustrate units that may be provided in an apparatus for a network node. The receiving unit 1601 and the transmitting unit 1602 are configured to support communications between network nodes.

Receiving and transmitting units need not necessarily be implemented separately, and a transceiver or transceiving unit or an interface circuit as shown by way of example at 332 in FIG. 3B or a communication unit as shown by way of example at 353 in FIG. 3C may support communications between network nodes.

Examples of processors or processing units are provided elsewhere herein, and may be implemented as the processing unit 1612.

An apparatus for a network node in a communication network that supports directed flooding for routing tree building as disclosed herein may include, with reference to FIG. 16 as an example, a processing unit 1612 configured to determine a restriction associated with a flooding message for building a routing tree in the communication network, and to handle the flooding message according to the restriction.

Examples related to such an apparatus, and other embodiments such as those related to instructions or programming, may include any one or more of the following features, for example, which are also discussed elsewhere herein:
the processing unit 1612 may be configured to handle the flooding message by including an indication of the restriction in the flooding message;
an apparatus may also include a transmitting unit 1602, configured (under control of the processing unit 1612 for example) to transmit the flooding message with the indication included in the flooding message;
the transmitting unit 1602 may be configured (under control of the processing unit 1612 for example) to transmit the flooding message only to one or more other nodes in the communication network at which the restriction is satisfied;
an apparatus may also include a receiving unit 1601, configured to receive the flooding message, in which case the processing unit 1612 may be configured to handle the flooding message by processing the flooding message where the restriction is satisfied, and otherwise discarding the flooding message;
the transmitting unit 1602 may be configured (or further configured) to transmit the flooding message after processing, where the restriction is satisfied;
in this context (transmitting after processing), the transmitting unit 1602 may be configured to transmit the flooding message, after processing: either to neighboring nodes of the network node in the communication network, or to only one or more of the neighboring nodes at which the restriction is satisfied;
the processing unit 1612 may be configured to determine the restriction by obtaining the restriction from the received flooding message;
the restriction may be based on any one or more of the following: angles relative to a root node of the routing tree, a distance from the root node of the routing tree, a set of network node identities;
the restriction may be one of multiple restrictions associated with the flooding message;
the multiple restrictions may include any one or more of the following: restrictions based on respective angles relative to a root node of the routing tree, restrictions based on respective distances from the root node of the routing tree, restrictions based on respective times, restrictions based on respective levels of loading in the communication network, restrictions based on respective sets of network node identities;
the processing unit 1612 may be further configured to determine a revised restriction that is based on the restriction and a second restriction associated with building a second routing tree in the communication network;
the processing unit 1612 may be further configured to handle a second flooding message according to the revised restriction;
the network node may have an address in the communication network that is indicative of a geographic location of the network node, to enable routing toward the network node from outside the routing tree.

The foregoing examples (and further examples herein) are intended to be illustrative and non-limiting. More generally, an apparatus or a component thereof may be configured to, or instructions or programming may (when executed) cause an apparatus or a component thereof to perform any of the operations or provide any of the features disclosed herein.

Other features disclosed herein may also or instead be provided or supported in apparatus examples. For example, an apparatus or a component thereof may be configured to perform any step or operation that is disclosed in the context of a method.

Apparatus examples are not in any way restricted to single devices. A communication system, for example, may include network nodes among which a flooding message for building a routing tree is distributed. Each of the network nodes may be configured to perform a method as disclosed herein.

In various embodiments, the present disclosure incudes features that may be applied in, for example, a TN/NTN communication system such as an LEO satellite constellation with terminals that connect to nearby ground stations via (possibly multi-hop) ISL links. Routing paths may be built using routing trees that originate at ground stations and radiate upward and outward according to teachings herein. The routing trees may be periodically refreshed, and entries may periodically evaporate and no longer be part of the routing trees to allow for consistency despite satellite motion. Instead of radiating just symmetrically, the routing trees can be built by radiating in a non-symmetric manner, and routing tree building may be limited in various ways. Furthermore, in some embodiments packets can still reach routing trees beyond the normal range of those trees by using geographic addressing to get closer to the tree edge. MPLS and/or other L2 methods can be used to form tunnels that forward along the routing trees.

Products to which embodiments herein may be applicable include, for example, any of the following:
terminals participating in a satellite network such as an LEO satellite network (next generation UE/smart phones that are LEO capable, for example);
ground stations participating in a satellite network such as an LEO satellite network;
satellites such as LEO satellites, with ISL links.

Features disclosed herein could also or instead be used in non-satellite networks, such as in earth-based or sky-based networks with moving forwarding nodes, including mesh networks.

In various embodiments herein, parameters such as angles and distance (radius, for example) of flooding may be set as shown by way of example in FIGS. 5 to 11, and may be a function of time, load, or both as described by way of example with reference to FIG. 8. Flooding message restrictions control flooding and routing tree building, and may be established by operations, administration, and management (OA&M) and set in a network node configuration, for example.

Flooding message restrictions or parameters such as radius and angles of flooding may be established based on any of various criteria or conditions, including state or status of nearby network nodes such as ground stations, for example. Examples of network node state criteria, any one or more of which may be taken into account as basis for establishing flooding message restrictions or parameters, include whether a network node is operating (“up”) or not operating (“down”), and current load.

One or multiple restrictions such as a respective radius and respective angles for multiple flood sectors, may be indicated in a flooding message. Multi-sector examples in which a flooding message may indicate multiple restrictions are shown in FIGS. 7 to 9.

Flood messages that are received by a network node may be discarded where a restriction is not satisfied. A flood message may be received by a network node at which a restriction based on radius/angles/times relative to origin of the flood message is not met, for example. Other examples of restrictions and how they impact flood message handling are also provided herein.

Some embodiments involve including and processing a list of network nodes (listed by node identity), such as network nodes to exclude when flooding.

Use of geographic addressing, and use of geographic addresses in routing, as disclosed herein, allow a network node within a routing tree, such as the root network node, to be reached from beyond the routing tree.

Reverse source route checking may be provided or supported in some embodiments. For example, reverse source route checking may be provided or supported within a routing tree but turned off or disabled otherwise because geographic routing works beyond the routing tree.

Directed flooding and routing tree building as disclosed herein may allow different densities of coverage, by ground stations for example, based on such parameters as direction, distance, time, and load, in any combination. This may be especially useful, for example, over water or in other areas where particular directions do not have ground stations for thousands of miles but other directions are well covered and reverse bent pipe or one ISL hop is sufficient. Near the edges of coastlines or sparsely populated areas, network access reach may be directional, and thus making the networking directional by using directed flooding and routing tree building may provide for reduced messaging overhead while still reaching deeply into such sparsely populated areas, thereby potentially reducing cost while increasing access.

In the present disclosure, the terms “a”, “an” and “one” are defined to mean “at least one”, that is, these terms do not exclude a plural number of items, unless stated otherwise.

In the present disclosure, terms such as “substantially”, “generally” and “about”, which modify a value, condition or characteristic of a feature of an example embodiment, should be understood to mean that the value, condition or characteristic is defined within tolerances that are acceptable for the proper operation of this example embodiment for its intended application.

In the present disclosure, unless stated otherwise, the terms “connected” and “coupled”, and derivatives and variants thereof, refer herein to any structural or functional connection or coupling, either direct or indirect, between two or more elements. For example, the connection or coupling between the elements can be acoustical, mechanical, optical, electrical, thermal, logical, or any combinations thereof.

In the present disclosure, expressions such as “match”, “matching” and “matched”, including variants and derivatives thereof, are intended to refer herein to a condition in which two or more elements are either the same or within some predetermined tolerance of each other. That is, these terms are meant to encompass not only “exactly” or “identically” matching the two elements but also “substantially”, “approximately” or “subjectively” matching the two or more elements, as well as providing a higher or best match among a plurality of matching possibilities.

In the present disclosure, the expression “based on” is intended to mean “based at least partly on”, that is, this expression can mean “based solely on” or “based partially on”, and so should not be interpreted in a limited manner. More particularly, the expression “based on” could also be understood as meaning “depending on”, “representative of”, “indicative of”, “associated with” or similar expressions.

In the present disclosure, the terms “system” and “network” may be used interchangeably in embodiments of this application. “At least one” means one or more, and “a plurality of” means two or more. The term “and/or” describes an association relationship of associated objects, and indicates that three relationships may exist. For example, A and/or B may indicate the following three cases: Only A exists, both A and B exist, and only B exists, where A and B may be singular or plural. The character “/” usually indicates an “or” relationship between associated objects. “At least one of the following items (pieces)” or a similar expression thereof indicates any combination of these items, including a single item (piece) or any combination of a plurality of items (pieces). For example, “at least one of A, B, or C” includes: only A; only B; only C; A and B; A and C; B and C; or A, B, and C, and “at least one of A, B, and C” may also be understood as including: only A; only B; only C; A and B; A and C; B and C; or A, B, and C. In addition, unless otherwise specified, ordinal numbers such as “first” and “second” in embodiments of this application are used to distinguish between a plurality of objects, and are not used to limit a sequence, a time sequence, priorities, or importance of the plurality of objects.

The terms “receive”, “detect” and “decode” as used herein can have several different meanings depending on the context in which these terms are used. For example, without special note, the term “receive” may indicate that information (e.g., DCI, or MAC-CE, RRC signaling or TB) is received successfully by the receiving node, which means the receiving side correctly detects and decodes it. In this scenario, “receive” may cover “detect” and “decode” or may indicate the same thing, e.g., “receive paging” means decoding paging correctly and obtaining the paging successfully, accordingly, “the receiving side does not receive paging” means the receiving side does not detect and/or decoding the paging. The phrase “paging is not received” means the receiving side tries to detect and/or decoding the paging, but does not obtain the paging successfully. The term “receive” may sometimes indicate that a signal arrives at the receiving side, but does not mean the information in the signal is detected and decoded correctly, and then the receiving side performs detecting and decoding on the signal to obtain the information carried in the signal. In this scenario, “receive”, “detect” and “decode” may indicate different procedures at the receiving side to obtain the information.

A person skilled in the art should understand that embodiments of this application may be provided as a method, an apparatus (or system), computer-readable storage medium, or a computer program product. Therefore, this application may use a form of a hardware-only embodiment, a software-only embodiment, or an embodiment with a combination of software and hardware. Moreover, this application may use a form of a computer program product that is implemented on one or more computer-usable storage media (including but not limited to a disk memory, an optical memory, and the like) that include computer-usable program code.

This application is described with reference to the flowcharts and/or block diagrams of the method, the device (system), and the computer program product according to this application. It should be understood that computer program instructions may be used to implement each process and/or each block in the flowcharts and/or the block diagrams and a combination of a process and/or a block in the flowcharts and/or the block diagrams. The computer program instructions may be provided for a general-purpose computer, a dedicated computer, an embedded processor, or a processor of another programmable data processing device to generate a machine, so that the instructions executed by the computer or the processor of the another programmable data processing device generate an apparatus for implementing a specific function in one or more procedures in the flowcharts and/or in one or more blocks in the block diagrams.

The computer program instructions may alternatively be stored in a computer-readable memory that can indicate a computer or another programmable data processing device to work in a specific manner, so that the instructions stored in the computer-readable memory generate an artifact that includes an instruction apparatus. The instruction apparatus implements a specific function in one or more procedures in the flowcharts and/or in one or more blocks in the block diagrams.

The computer program instructions may alternatively be loaded onto a computer or another programmable data processing device, so that a series of operations and steps are performed on the computer or the another programmable device, so that computer-implemented processing is generated. Therefore, the instructions executed on the computer or the another programmable device provide steps for implementing a specific function in one or more procedures in the flowcharts and/or in one or more blocks in the block diagrams.

It is clear that a person skilled in the art can make various modifications and variations to this application without departing from the scope of this application. This application is intended to cover these modifications and variations of this application provided that they fall within the scope of protection defined by the following claims and their equivalent technologies.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Although aspects of the disclosure of the present invention have been described with reference to specific features and example embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although embodiments and potential advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer readable or processor readable storage medium or media for storage of information, such as computer readable or processor readable instructions, data structures, program modules, and/or other data. A non-exhaustive list of examples of non-transitory computer readable or processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and nonremovable media implemented in any method or technology, random-access memory (RAM), read-only memory (ROM), electrically erasable programmable read-only memory (EEPROM), flash memory or other memory technology. Any such non-transitory computer readable or processor readable storage media may be part of a device or accessible or connectable thereto. Any application or module herein described may be implemented using instructions that are readable and executable by a computer or processor may be stored or otherwise held by such non-transitory computer readable or processor readable storage media.

1. A method comprising:
determining, at a network node in a communication network, a restriction associated with a flooding message for building a routing tree in the communication network; and
handling the flooding message, at the network node, according to the restriction.

2. The method of claim 1, wherein handling the flooding message comprises:
including an indication of the restriction in the flooding message; and
transmitting the flooding message with the indication included in the flooding message.

3. The method of claim 2, wherein transmitting the flooding message comprises transmitting the flooding message only to one or more other network nodes in the communication network at which the restriction is satisfied.

4. The method of claim 1, further comprising:
receiving the flooding message,
wherein handling the flooding message comprises:
processing the flooding message where the restriction is satisfied, and otherwise discarding the flooding message.

5. The method of claim 4, wherein handling the flooding message further comprises:
transmitting the flooding message after processing, where the restriction is satisfied,
wherein transmitting the flooding message after processing comprises transmitting to neighboring nodes of the network node in the communication network, or transmitting only to one or more of the neighboring nodes at which the restriction is satisfied.

6. The method of claim 4, wherein determining the restriction comprises obtaining the restriction from the flooding message.

7. The method of claim 1, wherein the restriction is based on any one or more of the following:
angles relative to a root node of the routing tree;
a distance from the root node of the routing tree;
a set of network node identities.

8. The method of claim 1, wherein the restriction comprises one of a plurality of restrictions associated with the flooding message, the plurality of restrictions comprising any one or more of the following:
restrictions based on respective angles relative to a root node of the routing tree;
restrictions based on respective distances from the root node of the routing tree;
restrictions based on respective times;
restrictions based on respective levels of loading in the communication network;
restrictions based on respective sets of network node identities.

9. The method of claim 1, further comprising:
determining, at the network node, a revised restriction that is based on the restriction and a second restriction associated with building a second routing tree in the communication network; and
handling a second flooding message, by the network node, according to the revised restriction.

10. The method of claim 1, wherein the network node has an address in the communication network that is indicative of a geographic location of the network node, to enable routing toward the network node from outside the routing tree.

11. An apparatus for a network node in a communication network, the apparatus comprising:
a processing unit, configured to determine a restriction associated with a flooding message for building a routing tree in the communication network;
the processing unit being further configured to handle the flooding message according to the restriction.

12. The apparatus of claim 11, wherein the processing unit is configured to handle the flooding message by including an indication of the restriction in the flooding message, wherein the apparatus further comprises:
a transmitting unit, configured to transmit the flooding message with the indication included in the flooding message.

13. The apparatus of claim 12, wherein the transmitting unit is configured to transmit the flooding message only to one or more other nodes in the communication network at which the restriction is satisfied.

14. The apparatus of claim 11, further comprising:
a receiving unit, configured to receive the flooding message,
wherein the processing unit is configured to handle the flooding message by processing the flooding message where the restriction is satisfied, and otherwise discarding the flooding message.

15. The apparatus of claim 14, further comprising:
a transmitting unit, configured to transmit the flooding message after processing, where the restriction is satisfied,
wherein the transmitting unit is configured to transmit the flooding message, after processing: either to neighboring nodes of the network node in the communication network, or to only one or more of the neighboring nodes at which the restriction is satisfied.

16. The apparatus of claim 14, wherein the processing unit is configured to determine the restriction by obtaining the restriction from the flooding message.

17. The apparatus of claim 11, wherein the restriction is based on any one or more of the following:
angles relative to a root node of the routing tree;
a distance from the root node of the routing tree;
a set of network node identities.

18. The apparatus of claim 11, wherein the restriction comprises one of a plurality of restrictions associated with the flooding message, the plurality of restrictions comprising any one or more of the following:
restrictions based on respective angles relative to a root node of the routing tree;
restrictions based on respective distances from the root node of the routing tree;
restrictions based on respective times;
restrictions based on respective levels of loading in the communication network;
restrictions based on respective sets of network node identities.

19. The apparatus of claim 11, wherein the processing unit is further configured to:
determine a revised restriction that is based on the restriction and a second restriction associated with building a second routing tree in the communication network; and
handle a second flooding message according to the revised restriction.

20. The apparatus of claim 11, wherein the network node has an address in the communication network that is indicative of a geographic location of the network node, to enable routing toward the network node from outside the routing tree.
